(19) United States
(12) Patent Application Publication
(10) Pub. No.: US 2024/0104362 A1
(43) Pub. Date: Mar. 28, 2024

(54) SPATIO-TEMPORAL INTELLIGENT DIGITAL MEMORY SYSTEMS AND METHODS

(71) Applicant: University of Florida Research Foundation, Incorporated, Gainesville, FL (US)

(72) Inventors: Swarup Bhunia, Gainesville, FL (US); Prabuddha Chakraborty, Gainesville, FL (US)

(21) Appl. No.: 18/451,509

(22) Filed: Aug. 17, 2023

Related U.S. Application Data
(60) Provisional application No. 63/374,840, filed on Sep. 7, 2022.

(51) Int. Cl. G06N 3/063; G06N 3/0985

(52) U.S. Cl. CPC G06N 3/063; G06N 3/0985

(57) ABSTRACT

A computing entity comprising an intelligent digital memory system and one or more processors communicatively coupled to the intelligent digital memory system is provided. The one or more processors configured to receive one or more storage parameters, determine a store procedure cue neuron search location from candidate ones of a plurality of cue neurons associated with a neural memory network (NoK), insert the input data as a data neuron into the NoK based on the store procedure cue neuron search location, temporally link the data neuron with a location of last insertion, and modify the NoK in a manner of accessibility based on a pattern of a search for the store procedure cue neuron search location.

### CROSS REFERENCE TO RELATED APPLICATION

This application claims the priority of U.S. Provisional Application No. 63/374,840, entitled “SPATIO-TEMPORAL INTELLIGENT DIGITAL MEMORY SYSTEMS AND METHODS,” filed on Sep. 7, 2022, the disclosure of which is hereby incorporated by reference in its entirety.

### TECHNICAL FIELD

The present application relates to a computer system memory architecture, and more particularly to an intelligent digital memory system for edge computing devices.

### BACKGROUND

An Internet-of-things (IoT) system may comprise edge devices (ranging from a few to thousands depending on the application), networking infrastructures, central cloud/server, artificial intelligence (AI) imbued into the server and edge devices, and security measures to counteract any cyber threats. IoT systems are widely used for carrying a plethora of automation tasks in different domains such as industrial automation, smart infrastructure, smart agriculture, and surveillance systems, thereby transforming our lives and the industry. However, the efficiency of edge devices are of serious concern in many applications where (i) the edge devices are expected to sense a high volume of data, (ii) the data sensed by these edge devices arrive at very high velocity, (iii) the communication bandwidth available for each edge device is limited, (iv) the battery capacity of these edge devices are limited and low, (v) the edge devices have limited and small storage space on-device, or (vi) some form of artificial intelligence (AI) task is required to be performed by these edge devices. A few or all of the aforementioned requirements/conditions, when present, can significantly jeopardize the effectiveness of an IoT system.

Applicant has identified many technical challenges and difficulties associated with conventional memory/data management system, which is at the root of most of the above-mentioned problems.

### BRIEF SUMMARY

Various embodiments described herein relate to methods, apparatuses, and systems for processing data using an intelligent digital memory system. According to one embodiment, the intelligent digital memory system comprises a neural memory network comprising data neurons (representing data), cue neurons (representing data features), gist neurons (representing high level content/meaning of the data), spatial connections (representing spatial correlation), and temporal connections (representing temporal correlation).

In some embodiments, the intelligent digital memory system may comprise compute neurons representative of mobile computation units. In some embodiments, compute neurons may be strategically placed and relocated within the intelligent digital memory system based on data access behavior, user requirements, and data movement requirements. In some embodiments, the intelligent digital memory system may comprise a distributed spatio-temporal intelligent memory providing knowledge transfer between physically separated devices for joint knowledge extraction. In some embodiments, the intelligent digital memory system may comprise distributed spatio-temporal awareness comprising unique knowledge extraction by analyzing insights from data stored in multiple devices and past stored data history.

According to another embodiment, a method comprising memory operations of intelligent digital memory system is provided. The memory operations may comprise storing data based on spatial and temporal features, detecting redundant data based on similarity with existing data in the intelligent digital memory system and precluding storage of the redundant data, reorganizing the intelligent digital memory system based on an insertion pattern for better future access, and configuring a positive feedback mechanism to strengthen resolution of data accesses.

In some embodiments, data is retrieved based on spatial correlations and gist information. In some embodiments, data is retrieved based on joint spatio-temporal correlations. In some embodiments, a determination of which gist neurons to populate is made. In some embodiments, information is propagated from a given gist neuron to its neighboring gist neurons. In some embodiments, insights are determined with regards to spatio-temporal events/activities that are observed/stored by the intelligent digital memory system. In some embodiments, key data points stored inside the intelligent digital memory system are fetched. In some embodiments, a data retention operation is performed to introduce an aging process to parameters of the intelligent digital memory system, wherein the aging process may comprise (i) memory strength loss and compression of un-accessed data, (ii) weakening of unused associations in a memory graph, and (iii) determination of key data points stored in the intelligent digital memory system.

In accordance with various embodiments of the present disclosure, a computing entity is provided. In some embodiments, the computing entity comprises a memory system and one or more processors communicatively coupled to the memory system, the one or more processors configured to receive one or more storage parameters, the one or more storage parameters comprising input data and features associated with the input data; determine a store procedure cue neuron search location from candidate ones of a plurality of cue neurons associated with a neural memory network (NoK), the store procedure cue neuron search location comprising a most similar one of the plurality of cue neurons to the input data based on the features associated with the input data; insert the input data as a data neuron into the NoK based on the store procedure cue neuron search location; temporally link the data neuron with a location of last insertion; and modify the NoK in a manner of accessibility based on a pattern of a search for the most similar one of the plurality of cue neurons.

In some embodiments, the one or more processors are further configured to determine the input data is salient with respect to data in proximity to the store procedure cue neuron search location based on a saliency threshold value and insert the input data into the NoK based on the determination that the input data is salient. In some embodiments, the one or more processors are further configured to determine the input data is not salient with respect to data in proximity to the store procedure cue neuron search location based on a saliency threshold value, increase memory strength of data in proximity to the neuron search location based on the determination that the input data is not salient, and temporally link the neuron search location with the location of last insertion. In some embodiments, the one or more processors are further configured to: perform the search for the most similar one of the plurality of cue neurons until a search limit value is reached, insert the input data as the data neuron in a best location of the NoK encountered during the search, and temporally link the data neuron to the location of last insertion. In some embodiments, the one or more processors are further configured to receive one or more retrieval parameters, the one or more retrieval parameters comprising search features associated with a data request, fetch data associated with the data request based on a determination that a retrieve procedure cue neuron search location is in proximity to data matching the search features, increase memory strength of the fetched data, and modify the NoK in a manner of accessibility based on a pattern of a search for the retrieve procedure cue neuron search location. In some embodiments, the one or more retrieval parameters comprise gist information associated with the data request. In some embodiments, the one or more processors are further configured to select a next candidate cue neuron in the NoK neighbor for a potential next search step based on NoK connectivity and the gist information until the data matching the search features is in proximity to the retrieve procedure cue neuron search location.

In some embodiments, the one or more processors are further configured to receive one or more retrieval parameters comprising search features, a search limit value, gist information, and a data limit value; generate a results data structure; determine that a multi-retrieve procedure cue neuron search location is in proximity to data matching the search features; fetch and append data to the results data structure based on the data matching the search features; increase memory strength of the data appended to the results data structure; modify the NoK in a manner of accessibility based on a pattern of a search for the multi-retrieve procedure cue neuron search location; and return the results data structure comprising a plurality of data elements as output. In some embodiments, the one or more processors are further configured to: receive one or more retrieval parameters comprising search features, a search limit value, gist information, a temporal limit value, and a near or far value; generate a results data structure; determine that a spatio-temporal cue neuron search location is in proximity to data matching the search features; determine the data matching the search features is temporally consistent with the gist information based on the near or far value; fetch and append data to the results data structure based on the data matching the search features is temporally consistent with the gist information; increase memory strength of the data appended to the results data structure; modify the NoK in a manner of accessibility based on a pattern of a search for the spatio-temporal cue neuron search location; and return the results data structure comprising a sequence of data as output. In some embodiments, the one or more processors are further configured to: determine whether the data matching the search features is within a distance of the temporal limit value from other elements in the results data structure based on the near or far value comprising a near value; and determine whether the data matching the search features is at least the distance of the temporal limit value from the other elements in the results data structure based on the near or far value comprising a far value.

In some embodiments, the one or more processors are further configured to: receive a background identifier threshold and an activity highlight distance value; select one or more data neurons from the NoK within a degree greater than the background identifier threshold as background data neurons; for each background data neuron, perform a plurality of traces comprising unique paths to the background data neuron within the activity highlight distance value of hops; and return the plurality of traces comprising referential activities as output. In some embodiments, the one or more processors are further configured to: mark key data point locations in the NoK; assign a score to a data point at each of the key data point locations; and fetch one or more top key data points based on a search limit and respective scores of the one or more top key data points. In some embodiments, the NoK comprises one or more compute neurons and one or more data neurons, wherein the one or more compute neurons are configured to perform one or more operations on the one or more data neurons. In some embodiments, the one or more operations comprise one or more of creating new knowledge, updating data, or generating responses to queries. In some embodiments, the one or more compute neurons are located at one or more regions of the NoK comprising at least one of the one or more data neurons on which the one or more compute neurons are most likely to operate on.

In some embodiments, the NoK is distributed across a plurality of computing entities. In some embodiments, at least one of the plurality of computing entities is spatially aware of memory content of a second one of the plurality of computing entities via the NoK. In some embodiments, the NoK comprises one or more neurons configured to move across the plurality of computing entities based on one or more of change in data access behavior, change in data movement requirements, change in compute requirements, or memory user feedback. In some embodiments, the one or more processors are further configured to reduce association strengths of one or more of the plurality of cue neurons and one or more data neurons in the neural memory network and reduce memory strength of the one or more data neurons in the neural memory network. In some embodiments, the NoK comprises one or more memory hives associated with one or more respective data types.

### BRIEF DESCRIPTION OF THE DRAWINGS

Embodiments incorporating teachings of the present disclosure are shown and described with respect to the figures presented herein.

FIG. 1A, FIG. 1B, and FIG. 1C illustrate exemplary operation of a traditional content-addressable memory.

FIG. 2A illustrates data organization of traditional static memory.

FIG. 2B illustrates exemplary data look up in a data-aware memory.

FIG. 2C illustrates exemplary application-aware data size modulation.

FIG. 3A, FIG. 3B, and FIG. 3C illustrates exemplary search progression in a data retrieval operation in accordance with some embodiments discussed herein.

FIG. 4 illustrates exemplary temporal connectivity between data units in accordance with some embodiments discussed herein.

FIG. 5 illustrates exemplary saliency-based data retention in accordance with some embodiments discussed herein.

FIG. 6 illustrates a sample memory graph in accordance with some embodiments discussed herein.

FIG. 7 illustrates an exemplary set of compute neurons performing a variety of tasks in accordance with some embodiments discussed herein.

FIG. 8 illustrates an exemplary intelligent digital memory system distributed across multiple edge devices and a cloud in accordance with some embodiments discussed herein.

FIG. 9 illustrates distributed spatial awareness between two devices using an intelligent digital memory system in accordance with some embodiments discussed herein.

FIG. 10 illustrates distributed spatio-temporal awareness between two devices using an intelligent digital memory system in accordance with some embodiments discussed herein.

FIG. 11 provides an exemplary overview of an architecture that can be used to practice embodiments of the present disclosure.

FIG. 12 provides an example data analysis computing entity in accordance with some embodiments discussed herein.

FIG. 13 provides an example client computing entity in accordance with some embodiments discussed herein

FIGS. 14A and 14B illustrate example neural memory networks in accordance with some embodiments discussed herein.

FIG. 15 illustrates a flowchart of an exemplary method for storing data in accordance with some embodiments discussed herein.

FIG. 16 illustrates a flowchart of an exemplary method for retrieving data in accordance with some embodiments discussed herein.

FIG. 17 illustrates a flowchart of an exemplary method for retrieving a plurality of data items in accordance with some embodiments discussed herein.

FIG. 18 illustrates a flowchart of an exemplary method for aging memory in accordance with some embodiments discussed herein.

FIG. 19 illustrates a flowchart of an exemplary method for extracting gist information in accordance with some embodiments discussed herein.

FIG. 20 illustrates a flowchart of an exemplary method for fetching key data points in accordance with some embodiments discussed herein.

FIG. 21 illustrates a flowchart of an exemplary method for performing a spatio-temporal search operation in accordance with some embodiments discussed herein.

FIG. 22 illustrates a flowchart of an exemplary method for detecting activity of an intelligent digital memory system in accordance with some embodiments discussed herein.

### DETAILED DESCRIPTION

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### General Overview and Exemplary Technical Improvements

According to various embodiments of the present disclosure, an adaptable, aware, and intelligent brain-like digital memory may be able to solve many challenges being faced by modern IoT edge devices. The present application discloses an intelligent digital memory system incorporating temporal associativity among data units, content-aware data storing and searching, content-aware complex query answering, and content-aware event insight gathering.

### Digital Memory

Digital memory may comprise an integral part of a computer system and can play a key role in determining system performance. Memory access behavior may depend on the nature of input data and specific information-processing steps on the data. Systems ranging from wildlife surveillance to infrastructure damage monitoring that collect, store, and analyze data often exhibit distinct memory access (e.g., storage and retrieval of specific data blocks) behavior. Even within the same system, memory access behavior often changes with time. Hence, systems with variable and constantly evolving memory access patterns can benefit from a memory organization framework that can dynamically tailor itself based on such changes.

Traditional computing systems follow the Von Neumann architecture with a few exceptions (such as neural networks). In the Von Neumann architecture, a computing system may comprise a central processing unit and a memory unit, and together, these two components may process an input data/query to generate a desired output. With the Von Neumann architecture, the data-bus or the communication channel between the memory unit and the processing unit creates a power/speed bottleneck (a “Von Neumann Bottleneck”). Hence, efficient data movement and reducing data movement can lead to dramatic performance gain.

A similar data-to-processing unit bottleneck also exists between cloud and edge devices where the edge device is responsible for data collection while the cloud system performs complex processing. While fundamental memory technologies have evolved over the last decade (e.g., Intel Optane DC persistent memory, magnetoresistive random-access memory (MRAM), and resistive random-access memory (ReRAM)), little effort has been made in terms of how data is organized using these technologies. In most cases, existing memory architectures (especially for application-specific integrated circuit (ASIC) designs) are monolithic and locations in which data are stored inside memory have uniform impact on system performance.

Storage and retrieval of data in a computer memory may be a major factor in system performance. Traditionally, computer memory organization is “static,” e.g., it does not change based on application-specific characteristics in memory access behavior during system operation. Traditional memory systems can be broadly divided into two categories: (1) address-operated and (2) content-operated. In an address-operated memory (for example a Random Access Memory or RAM), the access during read/ write may be performed based on a memory address/location. During data retrieval/load, address operated memory may receive an address as input and returns the associated data. Certain computing applications, however, may be required to fetch data based on the content itself. Specifically, in the case of a content-operated memory (COM), access during read/write operations may be performed based on a search pattern.

Different variants of RAM such as SRAM (Static Random Access Memory) and DRAM (Dynamic Random Access Memory) can be used in a COM. However, in traditional COM, the association of a data block with a search pattern (or cues) and the granularity (details) of a stored data do not evolve. A traditional COM may not assign any specific data to a specific address during the store operation. During data retrieval/load, a search pattern/tag may be provided to a COM, and in response, the COM may search its entire memory system and return an address in the memory system where a retrieved data is stored. Such a process renders the search process extremely slow if performed sequentially. To speed up the process of content-based searching, parallelization may be employed which requires additional hardware. However, adding more hardware makes the COM an expensive solution limiting its large-scale usability.

A content-addressable memory (CAM), a variant of COM, can be implemented as standalone memory or through an abstraction over standard address-operated memory. CAMs may be designed to be precise and resistant to degradation over time. In most cases, a perfect match is required with respect to a search pattern/tag to qualify for a successful retrieval. This feature is essential for certain applications such as destination MAC address lookup for finding the forwarding port in a network device. However, when a CAM becomes full, it must replace old data units with new incoming data units based on a predefined replacement policy.

An instance retrieval (IR) framework may comprise a software wrapper on top of traditional memory systems that can be used for feature-based data storage and retrieval tasks. In an IR framework, during a code-book generation phase, visual words may be identified/learned based on features of an image dataset. These visual words may be, in most cases, cluster centroids of a feature distribution. Insertion of data in a memory system may follow and the data may be organized in a tree-like data structure. The location of each data may be determined based on the visual words (previously learned) that exist in the input image. During the retrieval phase, a search-image (or a search feature set) may be provided, and to search for similar data in the framework, a tree may be traversed based on visual words in the search image. If a good match exists with a stored image, then that specific stored image may be retrieved. An IR framework may be primarily used for storing and retrieving images. The learning component of an IR framework may be limited by the code-book generation phase, which takes place during initialization. Furthermore, once a data unit is inserted in the framework, no more location and accessibility change is possible. No associations exist between data units, and the granularity of data units does not change.

Intelligent cache replacement policies and data prefetching in processor-based systems may be implemented using an LSTM-based cache data block replacement approach to increase overall hit rate. Additional modules comprising a training trigger, a training module, and a prediction module may also be incorporated. Training an LSTM network can be computationally expensive; hence, an asynchronous training approach may be adopted using the training trigger module. This approach works best for a static database and does not scale well when old data is removed, and new data is added. However, a limitation arises due to the input length of the LSTM model and the representation of an individual input bit cannot be changed after deployment.

A memory data block prefetching approach using an LSTM-based model may be able to outperform table-based prefetching techniques. However, the efficiency of the LSTM-based model can be significantly reduced when the distribution of the access and cache misses change. It is also unclear whether a bulky recurrent neural network model such as LSTM can achieve acceptable performance when realized in hardware.

Human brain-inspired spatio-temporal hierarchical models such as Hierarchical Temporal Memory (HTM) may be used for pattern recognition and time-series analysis. However, HTM is not designed to be used as a data storage system that can replace traditional CAM.

Hence, a major limitation of traditional memory is that data in traditional memory are stored at a fixed quality/granularity. When a memory runs out of space, it can either stop accepting new data or remove old data based on a specific data replacement policy. Such traits of a traditional memory are tied to its ‘static’ nature, which makes it inefficient for many modern computing applications that have evolving access requirements. For example, a traditional memory, due to lack of dynamism, may statically store all incoming data at a same quality and with a same level of accessibility. This may lead to the storage of irrelevant data and uniform access time for both important and unimportant data units.

### Memory Requirements for IoT Edge Devices

Memory systems used by internet of things (IoT) devices at edges of networks may have unique requirements and constraints. These edge systems often operate under strict power, space, and bandwidth constraints limiting their capabilities. At the same time, these systems are often expected to sense a large volume of data, serve complex data-related queries in a reasonable amount of time, and transmit relevant data to the cloud. Additionally, IoT edge devices may deal with a large influx of data of varying importance while being constrained in terms of memory storage capacity, energy, and communication bandwidth. Hence, for these applications, it is important for a memory framework to be efficient in terms of energy, space, and transmission bandwidth utilization. Edge devices often also deal with multi-modal data, and the memory system must be flexible enough to manage inter-modality relations.

Most of these challenges can potentially be solved by addressing the memory-to-compute bottleneck and efficient application-oriented data organization, as disclosed herewith. Furthermore, an optimal data storage framework for IoT devices may be (1) dynamic in nature to accommodate for constantly evolving application requirements and scenarios, (2) able to exhibit virtually infinite capacity that can deal with a huge influx of sensor data—a common feature for many IoT applications, (3) capable of trading off data granularity with transmission and energy efficiency, and (4) able to efficiently handle multi-modal data in the context of the application-specific requirements. Traditional memories are not optimal for meeting the aforementioned features due to lack of flexibility in their memory organization and operations.

### Memory Requirements for IoT Cloud Server

A memory system at a cloud server may also deal with a high volume of data and are often inundated with fetch requests, complex queries, and data fetches for AI-model training. As such, a content and application aware memory, as disclosed herewith, can lead to improved performance for IoT cloud servers as well. Such an implementation can be done at the physical level or at the database level.

### Preliminary Analysis

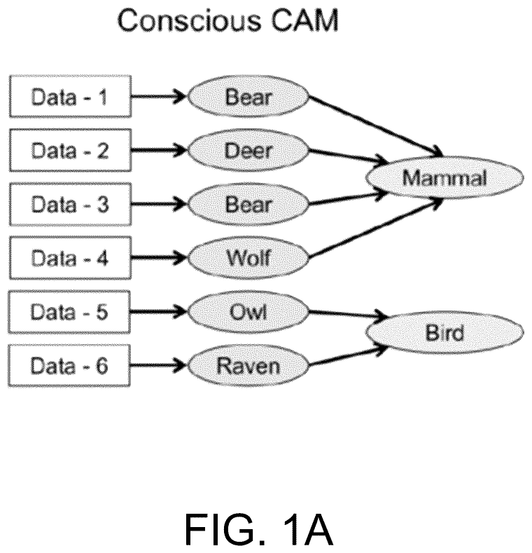

Proven by analyzing specific examples, the disclosed intelligent digital memory system can benefit a wide range of edge systems. In FIG. 1A, a traditional CAM storing images of different wildlife sightings is depicted. If this memory was intelligent, then the memory would know which data contained what type of sightings (indicated with blue and orange nodes). Referring to FIG. 1B, the number of searches (in worst-case) the CAM will have to make for retrieving a specific data unit with and without data-awareness is calculated. As shown, the search space is dramatically reduced if the memory is aware of the data it holds. In FIG. 1C, the space utilized by a CAM when a certain class is prioritized with and without data-awareness is calculated. It is assumed that prioritized data are allocated 10 units of space and unprioritized data are allocated 1 unit of space. According to FIG. 1C, an intelligent application-aware memory can efficiently modulate the data size of stored data based on the priority.

### Human-like Digital Memory

A typical human brain is aware of data it already holds. For example, when a person perceives an image of a dog and tries to figure out if the dog was seen, the person would only recall memories involving dogs. Such data-awareness also allows humans to quickly answer complex queries, make temporal links to events, and make causal links leading to intelligence. Additionally, a human brain also stores a large volume of data (an estimated 1020 bits of data) due to lossy objective-oriented (e.g., what's important) retention and operates with low energy. No two human brain perceives, stores and processes data in the same manner and most of the differences are due to what is important to the person in question and their life experiences. Embodiments of an intelligent digital memory system disclosed herein draw inspiration from the human brain which has evolved to deal with a large influx of data, perform fast, almost real-time data retrieval, serve complex spatio-temporal queries, perform retrospective learning based on stored data, operate with low energy, and adapt to ever-changing memory requirements.

The present application discloses an intelligent digital memory system comprising an improved COM framework that mimics the intelligence of a human brain for efficient storage and access of multi-modal data. The intelligent digital memory system may comprise a memory storage including a network of cues (search-patterns) and data, referred to herein as a neural memory network (NoK). Based on feedback generated from each memory operation, reinforcement learning may be applied to optimize NoK organization and adjust granularity (feature quality) of specific data units.

In some embodiments, the disclosed intelligent digital memory system may comprise a low-level memory organization where data granularity and association between data and search patterns evolve dynamically. In particular, the disclosed intelligent digital memory system may organize memory as a graph and dynamically (1) modify the graph structure and weights for increased accessibility and (2) adjust the details/granularity of each data unit/neuron stored in the memory based on memory access pattern. The disclosed intelligent digital memory system may comprise the same interface as any traditional COM and may be used to efficiently replace traditional COMs in any computing application. For example, computing applications that are resistant to imprecise data storage/retrieval and are associated with storing data of varying importance may benefit from the disclosed intelligent digital memory system.

Table 1 provides an example comparison between properties of an intelligent digital memory system, according to embodiments disclosed herein, traditional memory systems, and instance recognition frameworks. The disclosed intelligent digital memory system may comprise dynamic content-based data reorganization, data granularity adjustment, temporal awareness, and content awareness. The disclosed intelligent digital memory system may also comprise complex query answering, resulting in access-dependent data fetch effort. Such properties are optimal for edge systems and in many cases data-centers as well.

TABLE 1

| | | | Intelligent |
|---|---|---|---|
| | Traditional | Instance | Digital |
| | Memory | Recognition | Memory |
| Data-Aware Organization | No | Yes | Yes |
| Data Granularity | No | No | Yes |
| Adjustment | | | |
| Dynamic Organization | No | No | Yes |
| Layout | Linear | Tree | Graph |
| Temporal Awareness | No | No | Yes |
| Content Awareness | No | No | Yes |
| Access Time/Effort | Constant | Constant | History Based |
| Complex Query Support | No | No | Yes |

The disclosed intelligent digital memory may comprise useful properties, such as (1) virtually infinite capacity (the ability to deal with a huge influx of data of varying importance), (2) impreciseness (the tendency of memory to store and retrieve imprecise but approximately correct data), (3) plasticity (the ability to undergo internal change based on external stimuli), and (4) intelligence (the capability to learn from historical memory access patterns and improve storage/access efficiency).

An intelligent digital memory system according to various embodiments disclosed herein may comprise the following set of features:

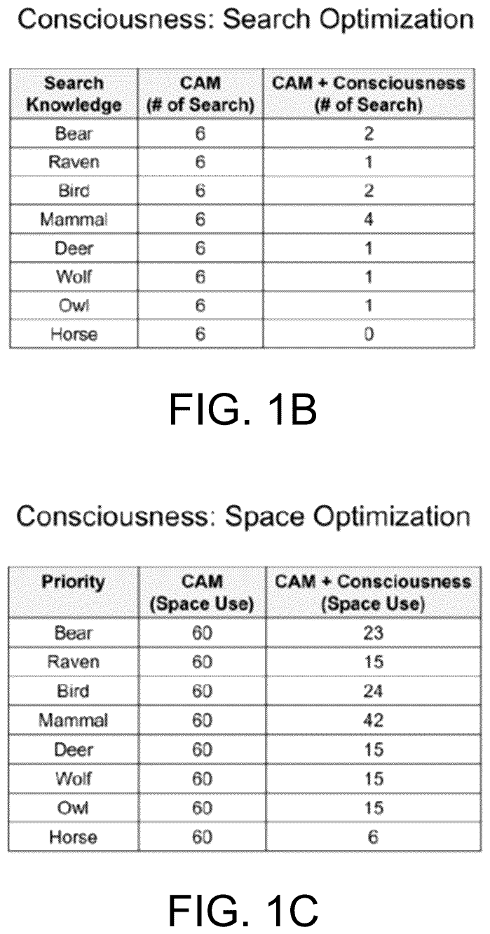

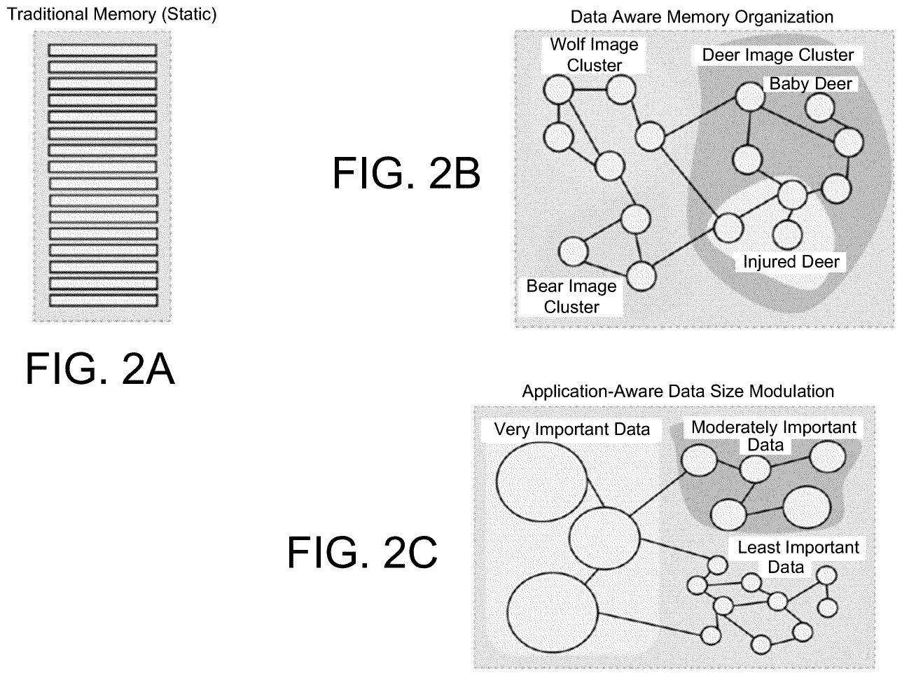

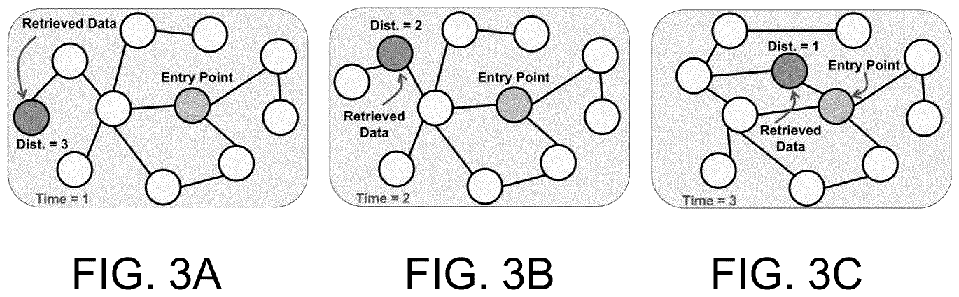

Content Aware Graph-like Spatial Organization: As an example, when a human person sees a dog and attempts to recall that specific dog, the person's brain may only search within dog-related memories. This content-aware search allows rapid data retrieval in the human brain and may be further facilitated by spatial data organization. As such, it may be desirable for the disclosed intelligent digital memory system to incorporate graph-like data organization, which may lead to efficient data searching because of similar data being organized (e.g., through machine learning) in a graph locality that limits search effort. A content aware graph-like spatial organization of memory is a departure from traditional ‘disconnected’ or ‘data-agnostic’ organization of static memory (FIG. 2A).

Referring to FIG. 2B, an example search for a specific “baby deer’ in a data-aware memory may take at most three look-ups while the same search may take up to 16 look-ups in case of the traditional static memory illustrated in FIG. 2A. Traditional memory is static in terms of both data organization and data memory application. Data-aware organization can also help answer complex queries such as “How many injured deer were observed?” or “Was a baby deer observed?” Data-aware memory organization can lead to better search efficiency and complex query answering.

Application-Aware Data Resolution Modulation: A human brain can store vast amounts of data. Such high volume of data storage is possible due to plasticity (the ability to change neural connection on the fly) and imprecise storage. Capturing plasticity in a digital memory through imprecise storage and a plastic organization of data may provide great benefits. For example, not all data may be relevant at a specific point in time. Hence, storing all data with equal level of details may not be optimal.

Application-aware dynamic data size modulation may be used to increase effective storage capacity. In some embodiments, a computing entity comprising an intelligent digital memory system may be configured to learn to assign a degree of importance (e.g., prioritization) to each data unit based on access behavior and as such, an appropriate amount of details can be retained for each data unit. The computing entity comprising the intelligent digital memory system may also be configured to allocate an appropriate amount of space to certain data depending on perceived importance of the data. Referring to FIG. 2C, for example, in a wildlife surveillance application aimed at detecting, storing, and processing deer images, any non-deer images can be assigned least importance. This may in turn allow for increased storage of more meaningful data which in this case are deer images.

Use-case Aware Dynamic Re-organization: Plasticity can be defined as the brain's capacity to respond to experienced demands with structural changes that alter the behavioral repertoire. This specific trait of a human brain allows context-switching between tasks and evolves the brain based on new requirements. Hence, in certain embodiments of the disclosed intelligent digital memory system, data may be re-organized depending on what is important for a specific computing application at a specific point of time. For example, some data may be more relevant to a computing application at a particular point of time and should be easier to access than less important data. Hence, a machine learning-driven (e.g., based on data access pattern) memory re-organization framework can be implemented to improved retrieval performance.

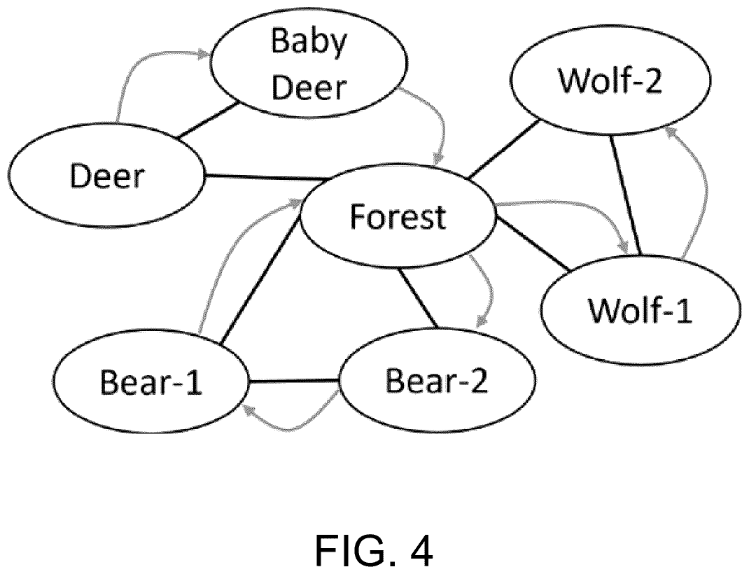

Referring to FIG. 3A, FIG. 3B, and FIG. 3C, a specific data unit (“Retrieved Data”) is depicted as progressively approaching closer to the search “Entry Point” (shown sequentially from FIG. 3A to FIG. 3C) via a learning-driven algorithm. For example, if a wildlife surveillance system originally designed to prioritize deer images suddenly switches context to prioritize wolf images, then over time the memory may be able to adapt to prioritize wolf images over deer images. Data access/retrieval driven memory re-organization can lead to progressively better retrieval performance for frequently accessed data.

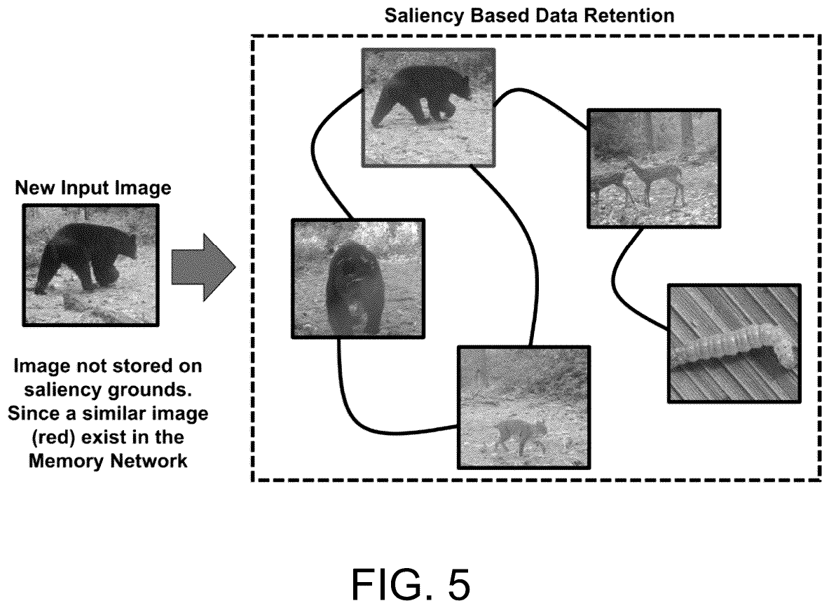

Temporal Awareness: A human brain may often store data as a temporal sequence. According to various embodiments of the present disclosure, an intelligent digital memory system may comprise a memory organization framework that can maintain temporal connectivity between data units for dealing with data sequences. As depicted in FIG. 4, temporal edges (shown by directed edges) may be directly embedded into a memory graph. Systems processing sequenced data can benefit from a data organization that has temporal edges. Such edges can help answer complex temporal queries without additional processing. This can help answer complex queries such as “Was a baby deer following an adult deer?” or “was a bear following a baby deer?” This can also form temporal loops where a similar frame/data is re-observed leading to more complex insights into the data stored. Each loop can potentially indicate an activity and the central node can indicate a reference frame.

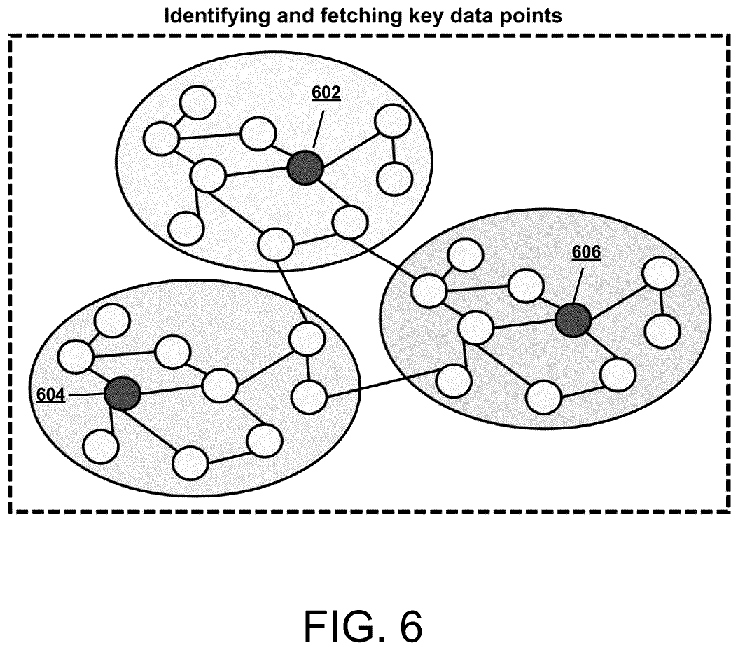

Saliency based Data Retention and Resizing: A human brain can avoid storing redundant data and thereby increasing the effective data storage space. Accordingly, a computing entity comprising an intelligent digital memory system according to various embodiments of the present disclosure may be configured with the ability to selectively store only those data that appear to be salient enough, thereby reducing redundant storage, and increasing search speed (e.g., less data to search from). Referring to FIG. 5, a new input image to a system is similar to one already inside. Based on this insight, the memory may decide not to store the new image and save space since it does not carry enough salient information.

Fetching Targeted Data: Feature-based data retrieval may be a common task that humans perform. Similarly, fetching a targeted data is a simple yet important task of any digital memory unit. Given features of a target data (e.g., reference features), the disclosed computing entity comprising an intelligent digital memory system may be configured to perform an intelligent data-aware search (with as minimal comparisons as possible) to retrieve the target data or a set of similar data.

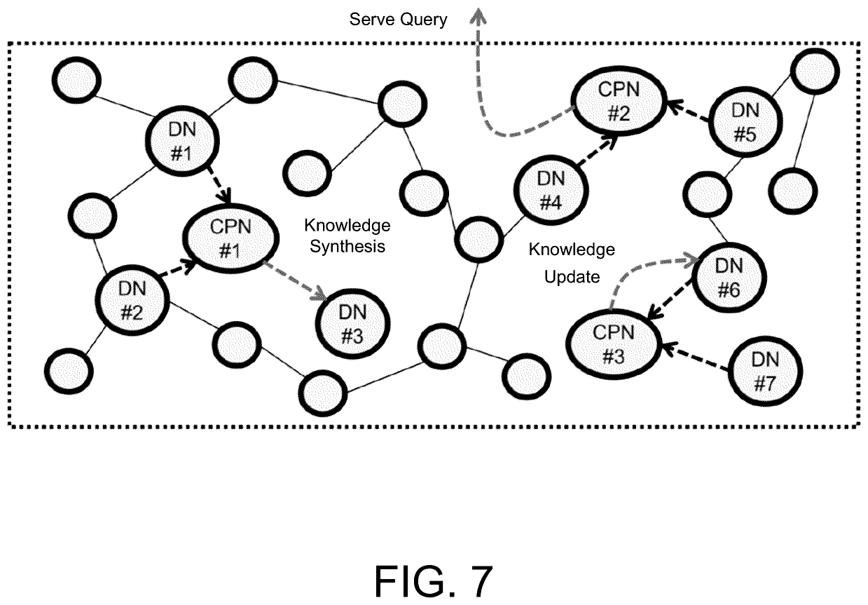

Fetching Key Data Points: The human brain can quickly analyze stored data and retrieve representative examples of different concepts and constructs. In many computing applications, it may be necessary to fetch a few key highly representative data points from all stored data for training artificial intelligence (AI) models and analyze the representative data points. According to various embodiments of the present disclosure, an intelligent digital memory system may store data in a graph format such that an intelligent sampling technique can easily identify a set of N key data points in the graph. Referring to FIG. 6. a sample memory graph is depicted with different loose clusters representing various types of data. Sampling the central points 602, 604, and 606 can be performed and may benefit certain applications. That is, key data points stored in the memory can be easily identified based on the loosely formed data neuron clusters in the graph.

Fetching Data guided by Temporal Correlation: The human brain can also temporally correlate events. According to various embodiments of the present disclosure, the disclosed computing entity comprising an intelligent digital memory system may be configured with temporal connectivity to enable searching for a specific set of data that are temporally correlated in a certain way. For example, the disclosed computing entity comprising the intelligent digital memory system may be configured to allow for a query of two images with certain features that are at most X temporal distance away. As another example, the disclosed computing entity comprising the intelligent digital memory system may be configured to allow a query for three images containing certain features that are at least X temporal distance away.

Gist Extraction and Propagation: The human brain not only spatially associates stored data, but it also identifies key traits and attributes associated with them. This allows rapid searching and complex processing. Data in a memory system may be organized based on spatial similarity, however, information about what these data represent may not be apparent without additional processing. For example, deer images may be stored nearby to form a cluster, but it is not necessarily known that these images contain deer sightings. As such, the disclosed intelligent digital memory system may be configured with a “gist” mechanism representative of high-level information to provide data content awareness. Extracting gist/high-level traits associated with a few data points and propagating that information in a neighborhood of nodes may provide significantly lower gist extraction effort.

Searching for Data Sequences: Due to temporal and spatial connectivity, the human brain is also particularly good at fetching a sequence of events. According to various embodiments of the present disclosure, the disclosed intelligent digital memory system is configured to use spatio-temporal connectives and efficiently retrieve event sequences in stored data.

Detecting and Retrieving Activity Loops: The human brain is remarkable at detecting recurring events with a frame of reference. The disclosed computing entity comprising the intelligent digital memory system, according to various embodiment of the present disclosure, may be configured to determine temporal events happening within a same frame of reference.

Compute Neurons: The disclosed intelligent digital memory system, according to various embodiment of the present disclosure, may employ compute neurons comprising computation units configured to perform a specific set of operations on selected data to, for example, synthesize new knowledge, update old knowledge with new, or answer specific queries. Compute neurons may be spatially placed in regions of an NoK containing data neurons on which the compute neurons are most likely to operate on. Doing such may reduce data movement within a computing device and across computing devices. The position of compute neurons may also change over time based on feedback from a memory user and data access pattern.

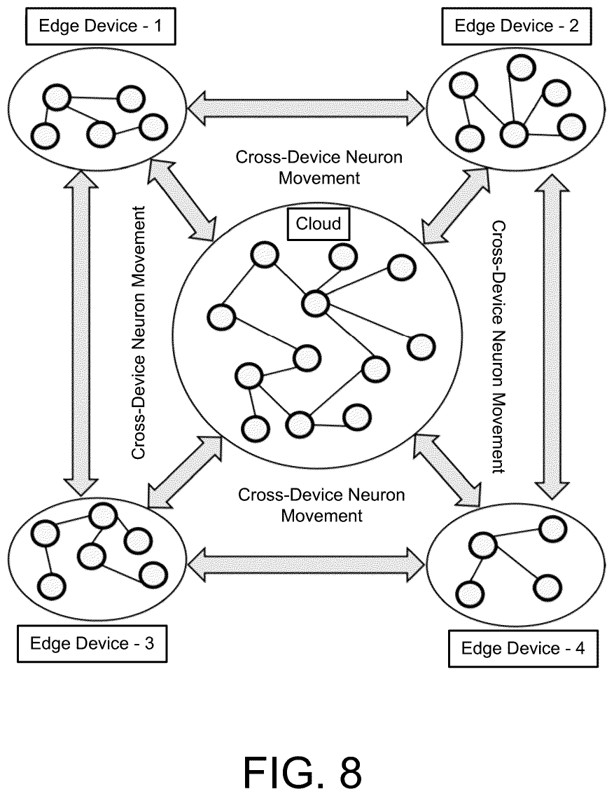

FIG. 7 presents an exemplary set of compute neurons performing a variety of tasks. Compute neurons may be used to create new knowledge (synthesis) from existing data, update data based on other information, or generate responses to queries. The compute neurons may be strategically placed within an NoK and dynamically moved around as required to reduce overall data movement.

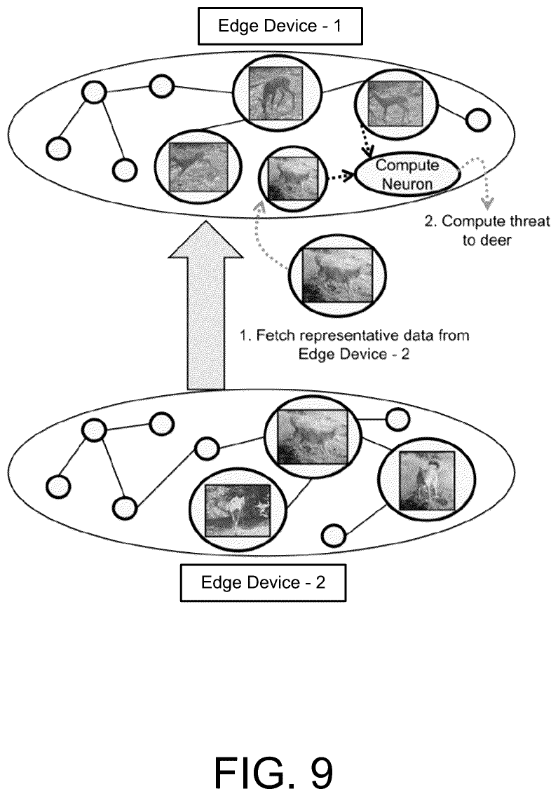

Distributed Intelligent Digital Memory System: According to various embodiments of the present disclosure, an intelligent digital memory system can be distributed across multiple devices and a cloud server. For example, an intelligent digital memory system can be distributed across multiple edge devices and a cloud, as illustrated in FIG. 8. Collective awareness of data and application may be created by a fluid organization of neurons for the disclosed intelligent digital memory system. As such, neurons can move across device boundaries and re-locate to another device or the cloud server such that overall memory efficiency of the system is optimized.

In some embodiments, a plurality of NoK neurons (e.g., data neurons, compute neurons, and gist neurons) may be able to move across different devices and the cloud depending on where the neurons are required the most. The movement may be based on change in data access behavior, change in data movement requirements, change in compute requirements, or memory user feedback.

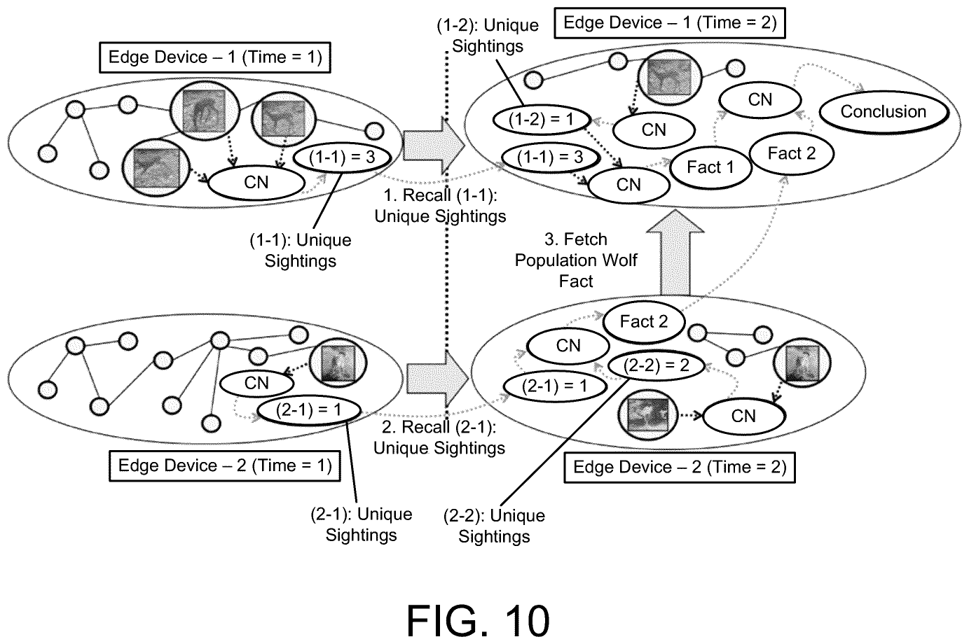

The disclosed intelligent digital memory system may also provide distributed spatial awareness where two devices using the intelligent digital memory system can leverage each other's knowledge, via a NoK, to draw conclusions. That is, the two devices can remain spatially aware of each-others memory content through communication of strategic information. Referring to FIG. 9, In this example, Edge Device-1 has observed (via compute neuron, denoted as “CN”) several deer and Edge Device-2 has observed several wolves/foxes. Edge Device-1 (e.g., having detected deer images) fetches the representative data from Edge Device-2 (e.g., having detected wolf/fox images) and computes the threat level for deer in the geographical region. Edge Device-1 can periodically fetch a few key (representative) data points from Edge Device-2 to compute any threat to the deer population.

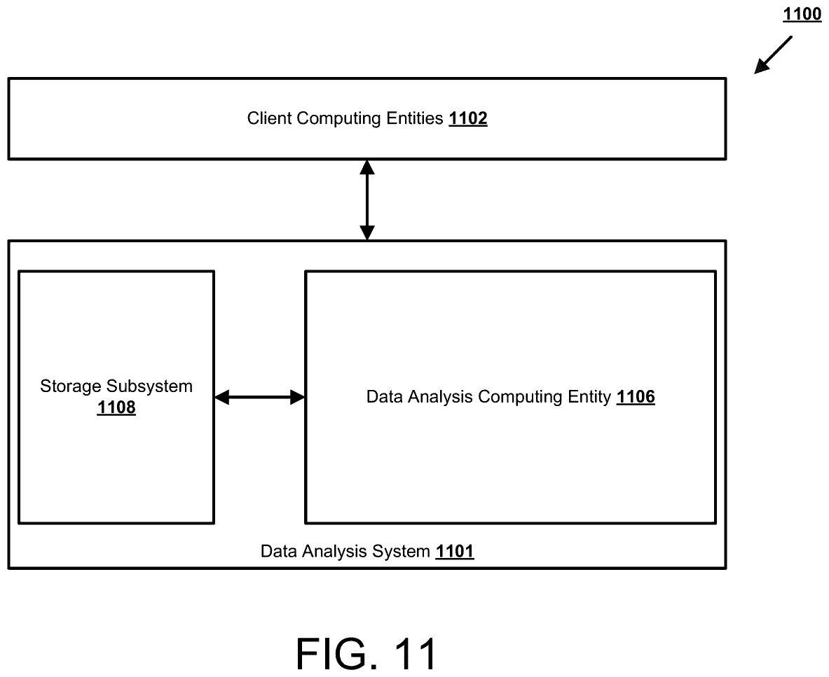

The disclosed intelligent digital memory system can also provide distributed spatio-temporal awareness, as shown in FIG. 10. Sharing of spatio-temporal awareness may allow knowledge synthesis and decision making to be based on past information and information from other devices. For example, the Edge Device-1 can detect a decline in deer population (“Fact 1”) through computing the number of unique sightings at two different time frames. Similarly, Edge Device-2 can detect an increase in wolf/fox population (“Fact 2”). Then Edge Device-1 can fetch insights (“Fact 2”) from Edge Device-2 to determine that deer population may be affected by the rise in wolf/fox population (“Conclusion”).

As depicted in FIG. 10, the Edge Device-1 at Time=1 computes the number of unique sightings (1-1)=3 of deer and the Edge Device-2 at Time=1 computes the number of unique sightings (2-1)=1 of wolf/fox. Then at Time=2, the Edge Device-1 re-computes unique sightings (1-2)=1 of deer and compares with its previous calculation of (1-1) to detect a “Fact: Deer Population Decreased.” Similarly, Edge Device-2 can detect a “Fact: Wolf Population Increased.” Then Edge Device-1 can fetch this insight from Edge Device-2 and infer that “Deer Population being affected by wolf population.”

The disclosed intelligent digital memory system can be used for serving different computing applications and purposes, such as the following:
1) precision agriculture: smart harvesting, unmanned aerial vehicles (UAV)/robot-based crop monitoring, pest detection systems;
2) smart cities: automation of city's facilities, street light control, city's surveillance system;
3) smart home: energy optimization, security, smart temperature control;
4) industrial automation: quality control, smart production line, machine-to-machine interactions;
5) smart transport systems: vehicle-to-vehicle coordination, smart traffic optimization;
6) medical systems: smart patient monitoring, medical wearables;
7) environmental monitoring: forest fire monitoring, wildlife monitoring, weather prediction systems; and
8) surveillance systems: industrial security systems, retail anti-theft surveillance systems.

For at least some of the above computing applications, a system may be built using a set of edge devices connected with each other and with a central server. Both edge devices and server can benefit from utilizing an intelligent digital memory system that provides storage space utilization reduction using saliency-based data storing, compression of unused data, rapid fetching of key data points for online AI-model training, rapid fetching of a specific set of data based on features based on user request or for AI-related tasks, joint spatial temporal fetching of data, automatic event and activity detection based on the stored data, memory re-organization for rapid search efficiency, efficient data insight extraction in form of gist information.

Accordingly, embodiments disclosed herein provide an intelligent digital memory system comprising one or more human brain-like operational features that can be implemented as a database management system or as physical memory. The disclosed intelligent digital memory system may be realized using memory operation algorithms described herewith. Setup, parameters, hyperparameters, interface and integration steps necessary to implement the disclosed memory system usable in a variety of computing applications are also described herewith.

### Exemplary Technical Implementation of Various Embodiments

Embodiments of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described with reference to example operations, steps, processes, blocks, and/or the like. Thus, it should be understood that each operation, step, process, block, and/or the like may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

### Exemplary System Architecture

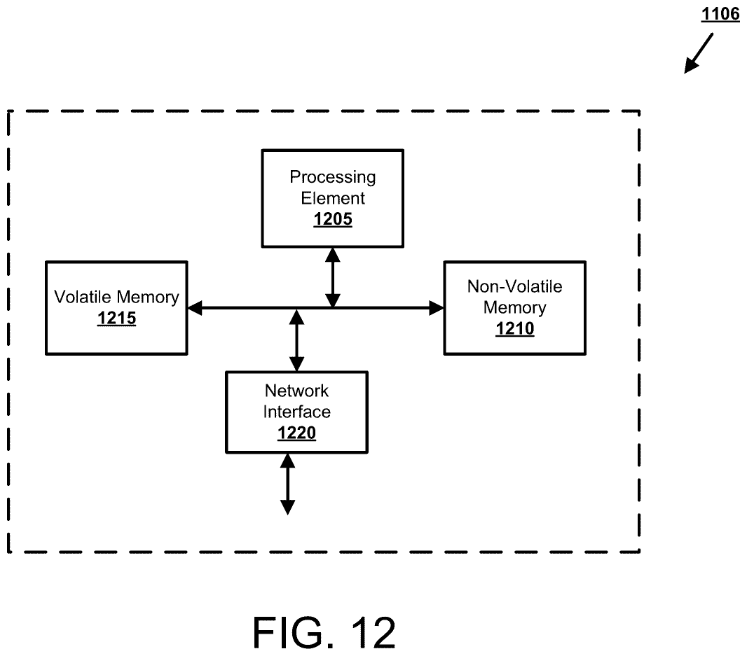

FIG. 11 is a schematic diagram of an example computer system architecture 1100 in accordance with various embodiments of the present disclosure. The architecture 1100 includes a data analysis system 1101 configured to receive data analysis requests from client computing entities 1102, process the data analysis requests to generate responses, provide the generated responses to the client computing entities 102, and automatically perform actions based on the generated responses.

An example of an action that can be performed using the data analysis system 1101 is a request for identifying events for surveillance images. For example, in accordance with various embodiments of the present disclosure, a predictive machine learning model may be trained to predict events using an intelligent digital memory system. Accordingly, the intelligent digital memory system may utilize techniques including temporal associativity among data units, content-aware data storing and searching, content-aware complex query answering, content-aware event insight gathering, atemporal connectivity among neurons and gist neurons for storing high-level content information, joint spatio-temporal searching, intelligent gist extraction, and in-memory activity insight generation. The disclosed intelligent digital memory system can lead to significant improvement in edge system performance for diverse applications. In doing so, the techniques described herein improve efficiency and speed of training predictive machine learning models, thus reducing the number of computational operations needed and/or the amount of training data entries needed to train predictive machine learning models. Accordingly, the techniques described herein improve at least one of the computational efficiency, storage-wise efficiency, and speed of training predictive machine learning models.

In some embodiments, data analysis system 1101 may communicate with at least one of the client computing entities 1102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The data analysis system 1101 may include a data analysis computing entity 1106 and a storage subsystem 1108. The data analysis computing entity 1106 may be configured to receive data analysis requests from one or more client computing entities 1102, process the data analysis requests to generate responses corresponding to the data analysis requests, provide the generated responses to the client computing entities 1102, and automatically perform actions based on the generated responses.

The storage subsystem 1108 may be configured to store input data used by the data analysis computing entity 1106 to perform data analysis as well as model definition data used by the data analysis computing entity 1106 to perform various data analysis tasks. The storage subsystem 1108 may include one or more storage units, such as multiple distributed storage units that are connected through a computer network. Each storage unit in the storage subsystem 1108 may store at least one of one or more data assets and/or one or more data about the computed properties of one or more data assets. Moreover, each storage unit in the storage subsystem 1108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. In some embodiments, the storage subsystem 1108 may comprise at least a portion of an intelligent digital memory system, as disclosed herewith.

### Exemplary Computing Entity

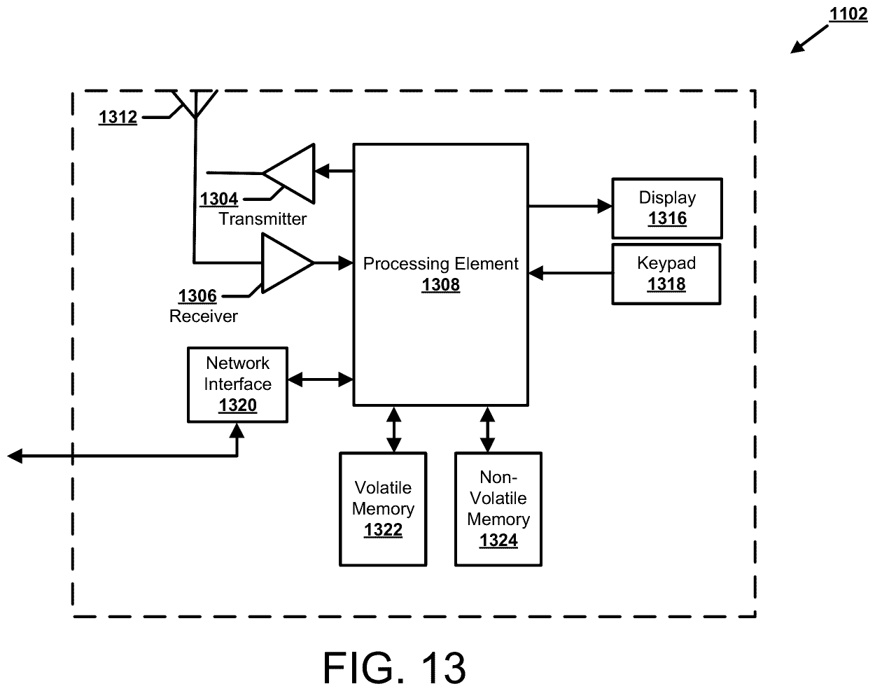

FIG. 12 provides a schematic of a data analysis computing entity 1106 according to one embodiment of the present disclosure. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the data analysis computing entity 1106 may also include one or more communications interfaces 1220 for communicating with various computing entities, such as by communicating data, content, information, and/or similar terms used herein interchangeably that can be transmitted, received, operated on, processed, displayed, stored, and/or the like.

As shown in FIG. 12, in one embodiment, the data analysis computing entity 1106 may include, or be in communication with, one or more processing elements 1205 (also referred to as processors, processing circuitry, and/or similar terms used herein interchangeably) that communicate with other elements within the data analysis computing entity 1106 via a bus, for example. As will be understood, the processing element 1205 may be embodied in a number of different ways.

For example, the processing element 1205 may be embodied as one or more complex programmable logic devices (CPLDs), microprocessors, multi-core processors, coprocessing entities, application-specific instruction-set processors (ASIPs), microcontrollers, and/or controllers. Further, the processing element 1205 may be embodied as one or more other processing devices or circuitry. The term circuitry may refer to an entirely hardware embodiment or a combination of hardware and computer program products. Thus, the processing element 1205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 1205 may be configured for a particular use or configured to execute instructions stored in volatile or non-volatile media or otherwise accessible to the processing element 1205. As such, whether configured by hardware or computer program products, or by a combination thereof, the processing element 1205 may be capable of performing steps or operations according to embodiments of the present disclosure when configured accordingly.

In one embodiment, the data analysis computing entity 1106 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile storage or memory media 1210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media 1210 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like. In some embodiments, the non-volatile storage or memory media 1210 may comprise at least a portion of an intelligent digital memory system, as disclosed herewith.

In one embodiment, the data analysis computing entity 1106 may further include, or be in communication with, volatile media (also referred to as volatile storage, memory, memory storage, memory circuitry and/or similar terms used herein interchangeably). In one embodiment, the volatile storage or memory may also include one or more volatile storage or memory media 1215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media 1215 may be used to store at least portions of the databases, database instances, database management systems, data, applications, programs, program modules, scripts, source code, object code, byte code, compiled code, interpreted code, machine code, executable instructions, and/or the like being executed by, for example, the processing element 1205. Thus, the databases, database instances, database management systems, data, applications, programs, program modules, scripts, source code, object code, byte code, compiled code, interpreted code, machine code, executable instructions, and/or the like may be used to control certain aspects of the operation of the data analysis computing entity 1106 with the assistance of the processing element 1205 and operating system. In some embodiments, the volatile storage or memory media 1215 may comprise at least a portion of an intelligent digital memory system, as disclosed herewith.

As indicated, in one embodiment, the data analysis computing entity 1106 may also include one or more communications interfaces 1220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the data analysis computing entity 1106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near-field communication (NFC) protocols, Wibree, Bluetooth protocols, wireless universal serial bus (USB) protocols, and/or any other wireless protocol.

Although not shown, the data analysis computing entity 1106 may include, or be in communication with, one or more input elements, such as a keyboard input, a mouse input, a touch screen/display input, motion input, movement input, audio input, pointing device input, joystick input, keypad input, and/or the like. The data analysis computing entity 1106 may also include, or be in communication with, one or more output elements (not shown), such as audio output, video output, screen/display output, motion output, movement output, and/or the like.

### Exemplary Client Computing Entity

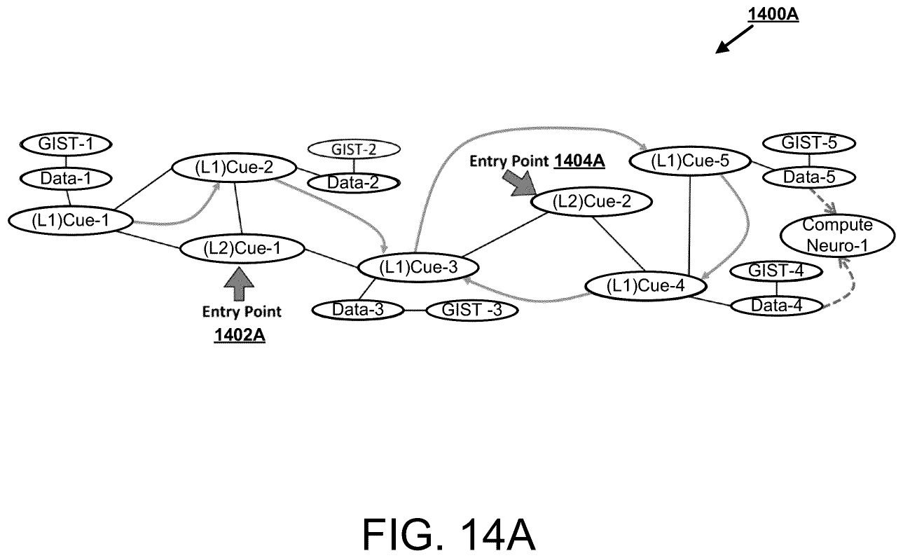

FIG. 13 provides an illustrative schematic representative of a client computing entity 1102 that can be used in conjunction with embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 1102 can be operated by various parties. As shown in FIG. 13, the client computing entity 1102 can include an antenna 1312, a transmitter 1304 (e.g., radio), a receiver 1306 (e.g., radio), and a processing element 1308 (e.g., CPLDs, microprocessors, multi-core processors, coprocessing entities, ASIPs, microcontrollers, and/or controllers) that provides signals to and receives signals from the transmitter 1304 and receiver 1306, correspondingly.

The signals provided to and received from the transmitter 1304 and the receiver 1306, correspondingly, may include signaling information/data in accordance with air interface standards of applicable wireless systems. In this regard, the client computing entity 1102 may be capable of operating with one or more air interface standards, communication protocols, modulation types, and access types. More particularly, the client computing entity 1102 may operate in accordance with any of a number of wireless communication standards and protocols, such as those described above regarding the data analysis computing entity 1106. In a particular embodiment, the client computing entity 1102 may operate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 1102 may operate in accordance with multiple wired communication standards and protocols, such as those described above regarding the data analysis computing entity 1106 via a network interface 1320.

Via these communication standards and protocols, the client computing entity 1102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 1102 can also download changes, add-ons, and updates, for instance, to its firmware, software (e.g., including executable instructions, applications, program modules), and operating system.

According to one embodiment, the client computing entity 1102 may include location determining aspects, devices, modules, functionalities, and/or similar words used herein interchangeably. For example, the client computing entity 1102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the client computing entity's 1102 position in connection with a variety of other systems, including cellular towers, Wi-Fi access points, and/or the like. Similarly, the client computing entity 1102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client computing entity 1102 may also comprise a user interface (that can include a display 1316 coupled to a processing element 1308) and/or a user input interface (coupled to a processing element 1308). For example, the user interface may be a user application, browser, user interface, and/or similar words used herein interchangeably executing on and/or accessible via the client computing entity 1102 to interact with and/or cause display of information/data from the data analysis computing entity 1106, as described herein. The user input interface can comprise any of a number of devices or interfaces allowing the client computing entity 1102 to receive data, such as a keypad 1318 (hard or soft), a touch display, voice/speech or motion interfaces, or other input device. In embodiments including a keypad 1318, the keypad 1318 can include (or cause display of) the conventional numeric (0-9) and related keys (#, *), and other keys used for operating the client computing entity 1102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The client computing entity 1102 can also include volatile storage or memory 1322 and/or non-volatile storage or memory 1324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z -RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the client computing entity 1102. As indicated, this may include a user application that is resident on the entity or accessible through a browser or other user interface for communicating with the data analysis computing entity 1106 and/or various other computing entities. In some embodiments, the volatile and non-volatile storage or memory may comprise at least a portion of an intelligent digital memory system, as disclosed herewith.

In another embodiment, the client computing entity 1102 may include one or more components or functionality that are the same or similar to those of the data analysis computing entity 1106, as described in greater detail above. As will be recognized, these architectures and descriptions are provided for exemplary purposes only and are not limiting to the various embodiments.

In various embodiments, the client computing entity 1102 may be embodied as an artificial intelligence (AI) computing entity, such as an Amazon Echo, Amazon Echo Dot, Amazon Show, Google Home, and/or the like. Accordingly, the client computing entity 1102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### Example System Operations

Various embodiments of the present disclosure describe steps, operations, processes, methods, functions, and/or the like for an intelligent digital memory system.

### Example Spatio-Temporal Memory Organization

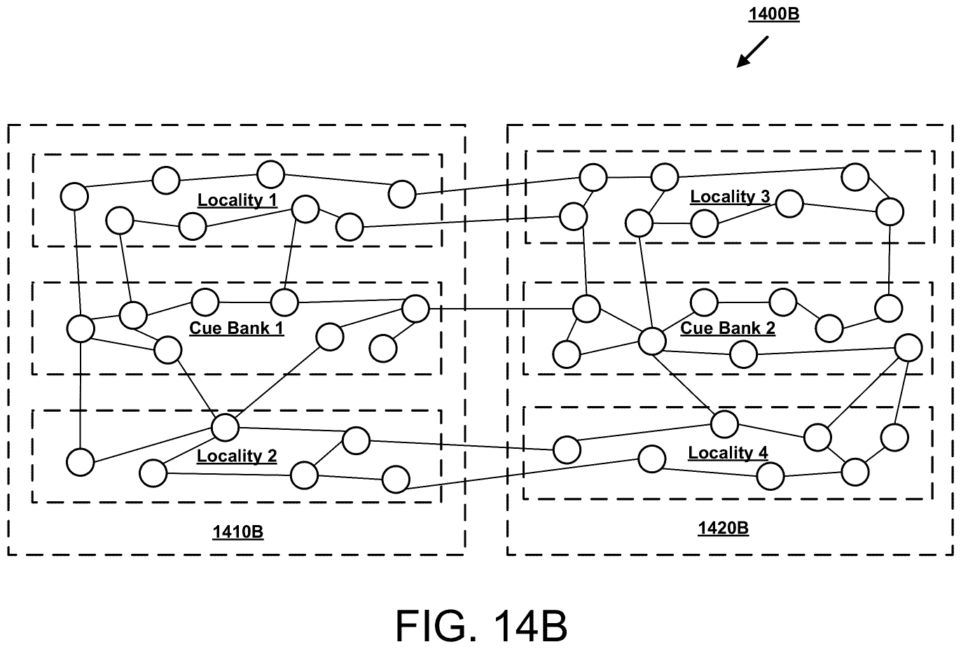

An intelligent digital memory system may organize data as an NoK. FIG. 14A depicts exemplary components in an NoK. The fundamental units of an NoK may comprise data neurons and cue neurons.

Data neurons may describe a data construct comprising actual data. That is, a data neuron may store an actual data unit. In some embodiments, a space allocated to a data neuron may change over time based on data-access pattern and perceived importance of the data. Each data neuron may be associated with a “memory strength” which governs its size and the quality of the data inside it.

A cue neuron may describe a data construct comprising a cue, such as a data search pattern or tag. A cue may be a vector, of variable dimension, representing a certain concept.

Cue neuron and data neuron associations in the NoK (<cue neuron, cue neuron> and <cue neuron, data neuron>, <data neuron, data neuron>) may change with time based on memory access pattern and hyperparameters. Data neuron memory strengths may also be modulated during memory operations to increase storage efficiency. To introduce the effect of aging, association weights and data neuron strengths may decay based on a user-defined periodicity. The effect of aging can be performed during a retention procedure. An NoK may further comprise gist neurons and compute neurons.

Gist neurons may describe a data construct comprising high-level knowledge associated with adjacent data neurons. Such knowledge can be leveraged to answer complex queries (without data fetching or additional computation) and speed up searching.

Compute neurons may describe a data construct comprising mobile computation units configured to perform computations within a physical vicinity (e.g., to reduce data movement) of data operated on. Compute neurons can also be moved around within the intelligent digital memory system in response to any change in memory access behavior and application requirements/user preferences

As depicted in FIG. 14A, NoK 1400A may comprise a network of level-2 (L2) cue neurons, level-1 (L1) cue neurons, data neurons, gist neurons, and compute neurons.

Level-2 cue neurons may describe a data construct comprising coarse-grained data features relevant to surrounding data in the NoK 1400A. Hence, level-2 cue neurons may be used for entry points 1402A and 1404A to the NoK 1400A, e.g., for searching proposes.

Level-1 cue neurons may describe a data construct comprising fine-grained data features associated with a set of data neurons. The fine-grained data features may be compared with for establishing a match to associated data neurons. Level-1 cue neurons may comprise more dimensions (e.g., associated with features and variables) than level-2 cues.

The depicted embodiment is described with reference to a 2-level cue system. However, according to some embodiments, N-levels of cue neurons may be used where N is any integer selected by a memory system administrator. For example, features of a level-(N) cue neuron may be finer than features of a level-(N+1) cue neuron. Conversely, features of a level-(N+1) cue may be coarser than features of a level-(N) cue.

For example, an intelligent digital memory system may be configured to support N different types of cues, in terms of their dimensions. Then, the cues with the biggest dimension/size among all the cues may be referred to as level-1 cues and the cues with the ith biggest dimension are referred to as level-i cues. Cues with the smallest dimension may be referred to as level-n cues. Level-n cues may be used as entry points into an NoK while, for example, searching for a specific data neuron and finding a suitable place to insert a new data neuron. For example, in a wildlife surveillance system, level-n cue neurons may contain vectors corresponding to high-level concepts such as “Wolf” or “Deer.” Level-1 cue neurons can contain more detailed image features of the stored data. Data neurons may be image frames containing wolves, deer, jungle background, etc.

The aforementioned neurons (data, cue, gist, and compute) may be connected to each other in two different dimensions: (1) spatial and (2) temporal. Spatial connections, depicted as undirected edges in FIG. 14A, may be formed between neurons based on content similarity. Temporal connections, depicted as directed edges in FIG. 14A, may comprise directed edges indicating a temporal order in which each neuron was created or re-sensed. Compute neurons may not be tightly coupled with any specific data neuron but may be kept in the vicinity of data that is probable to be operated on, e.g., to reduce data movement.

FIG. 14B depicts an NoK comprising two memory hives. An NoK may comprise multiple hives each of which may be used to store data of a specific modality (e.g., data type). As depicted in FIG. 14B NoK 1400B comprises memory hives storing a specific data type. Hive 1410B comprises an image hive for storing image data and hive 1420B comprises a sound hive for storing sound data. For example, if an application requires to store image and audio data, then the disclosed intelligent digital memory system may instantiate two separate memory hives for each data modality. This allows a search to be more directed based on query data type. Hive 1410B comprises “Locality 1,” “Cue Bank 1,” and “Locality 2.” Hive 1420B comprises “Locality 3,” “Cue Bank 2,” and “Locality 4.” Similar data neurons may accumulate to form localities. Additionally, to facilitate multi-modal data search, connections between data neurons across memory hives are allowed. For example, when searched with the cue “deer” (e.g., the visual feature of a deer), if the disclosed intelligent digital memory system is expected to fetch both images and sound data related to the concept of “deer,” then connections between data neurons across memory hives may save or reduce search effort.

### Example Intelligent Digital Memory System Operations

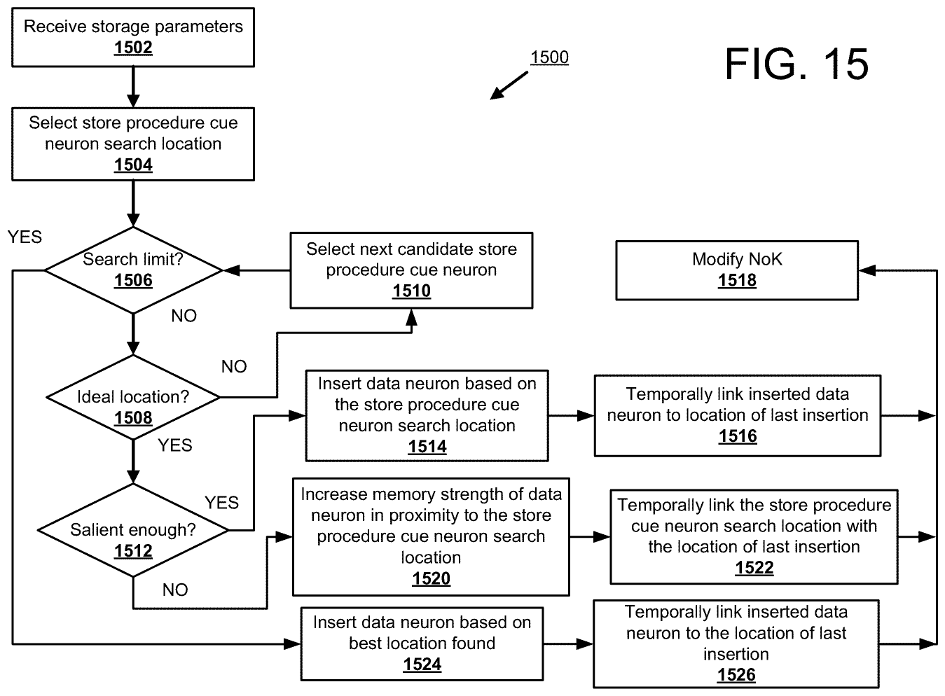

Store: Referring to FIG. 15, a flowchart of an example method for storing data in an intelligent digital memory system comprising memory, such as storage subsystem 1108, non-volatile memory 1210, volatile memory 1215, volatile memory 1322, and non-volatile memory 1324 is depicted. The flowchart depicted in FIG. 15 may correspond to storage operations performed by a processing element 1205 or a processing element 1308, in memory, or a combination of both, e.g., data analysis computing entity 1106 and client computing entity 1102 as they execute intelligent digital memory system storage operations in their respective volatile and/or non-volatile memory.

In some embodiments, method 1500 begins at step/operation 1502 when a computing entity receives storage parameters comprising input data, features associated with the input data, a search limit value, a saliency threshold value, and a location of last insertion. In some embodiments, at step/operation 1504, the computing entity selects a store procedure cue neuron search location for storing the input data comprising a starting point in an NoK based on the associated features. The selection of the starting point may be made based on a comparison of the features associated with the input data with key pre-identified cue neurons.

In some embodiments, at step/operation 1506, the computing entity compares a number of performed searches for the store procedure cue neuron search location with the search limit value. In some embodiments, if the number of searches has not reached the search limit value, then at step/operation 1508, the computing entity determines if the store procedure cue neuron search location is the optimal location for inserting the input data. The optimal location may comprise a cue neuron location comprising a most similar one of a plurality of candidate cue neurons to the features associated with the input data. In some embodiments, if the store procedure cue neuron search location is not the optimal location for inserting the input data, then at step/operation 1510, the computing entity selects a next candidate cue neuron in the NoK neighbor for potential insertion of the input data based on NoK connectivity and tracks a best match/location so far. The computing entity may iteratively search candidate cue neurons until the search limit value is reached (step/operation 1506) or until a candidate cue neuron is determined to be the optimal location for inserting the input data (step/operation 1508).

In some embodiments, at step/operation 1508, if the store procedure cue neuron search location is the optimal location for inserting the input data, then at step/operation 1512, the computing entity determines if the input data is salient enough with respect to data in proximity or adjacent to the store procedure cue neuron search location based on the saliency threshold value and the current store procedure cue neuron search location. If the new data is salient enough, then at step/operation 1514, the computing entity inserts the input data as a new data neuron into the NoK based on the store procedure cue neuron search location. In some embodiments, at step/operation 1516, the computing entity temporally links the inserted data neuron with the location of last insertion.

Returning to step/operation 1512, in some embodiments, if the data is not salient enough, then at step/operation 1520, the computing entity increases the memory strength of data in proximity or adjacent to the store procedure cue neuron search location. In some embodiments, at step/operation 1522, the computing entity temporally links the store procedure cue neuron search location with the location of last insertion.

Returning to step/operation 1506, in some embodiments, if the search limit value has been reached, then at step/operation 1524, the computing entity inserts the input data as a new data neuron in a best location encountered. In some embodiments, at step/operation 1526, the computing entity temporally links the inserted data neuron to the location of last insertion.

In some embodiments, at step 1518, the computing entity modifies the NoK based on a pattern of the search for the optimal location to ensure future access to that region (of the cue neuron search) is incrementally faster or more accessible. In particular, the computing entity may modify the NoK structure and association weights of cue neurons and/or data neurons for increased accessibility. In some embodiments, modifying the NoK comprises modifying neuron pathways such that one or more neurons may be bypassed in an access path while trying to reach specific neurons. In some embodiments, modifying the NoK comprises modifying association weights to give higher search priority to certain neuron pathways.

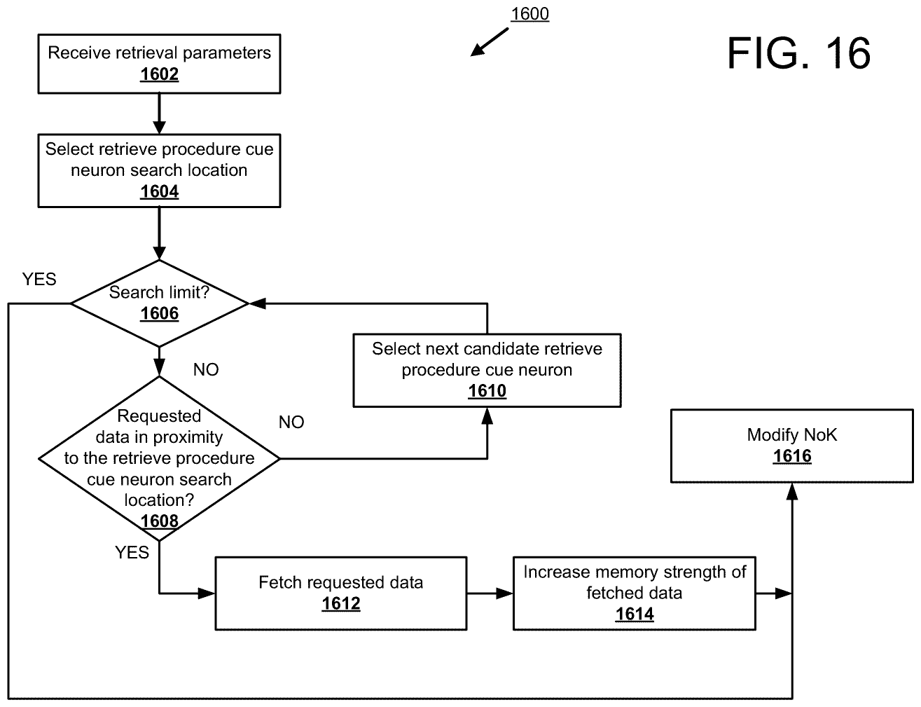

Load/Retrieve: Referring to FIG. 16 a flowchart of an example method for retrieving data from an intelligent digital memory system comprising memory, such as storage subsystem 1108, non-volatile memory 1210, volatile memory 1215, volatile memory 1322, and non-volatile memory 1324 is depicted. The flowchart depicted in FIG. 16 may correspond to retrieval operations performed by a processing element 1205 or a processing element 1308, in memory, or a combination of both, e.g., data analysis computing entity 1106 and client computing entity 1102 as they execute intelligent digital memory system retrieval operations in their respective volatile and/or non-volatile memory.

In some embodiments, method 1600 begins at step/operation 1602 when a computing entity receives retrieval parameters comprising search features associated with a data request, a search limit value, and gist information. The search features may comprise one or more characteristics, properties, or attributes of data being requested for retrieval, such as a particular categorization, or having specific content, e.g., text, words, or phrases. The search limit value may comprise a threshold on a number of search operations, such as node traversals, allowed for a particular search. The gist information may comprise a high-level description of the content of data being requested for retrieval.

In some embodiments, at step/operation 1604, the computing entity determines a retrieve procedure cue neuron search location for retrieving requested data comprising a starting point where a search will originate by selecting a retrieve procedure cue neuron search location in an NoK based on the search features. The starting point may be selected based on a comparison of the search features with key pre-identified cue neurons.

In some embodiments, at step/operation 1606, the computing entity compares a number of performed searches for the retrieve procedure cue neuron search location with the search limit value. In some embodiments, if the number of searches has not reached the search limit value, then at step/operation 1608, the computing entity determines if the requested data matching the search features is in proximity or adjacent to the retrieve procedure cue neuron search location. In some embodiments, if the requested data is not in proximity or adjacent to the retrieve procedure cue neuron search location, then at step/operation 1610, the computing entity selects a next candidate cue neuron in the NoK neighbor for a potential next search step based on NoK connectivity and the gist information. The computing entity may iteratively search candidate cue neurons until the search limit is reached (step/operation 1606) or until the requested data matching the search features is in proximity or adjacent to the retrieve procedure cue neuron search location (step/operation 1608).

Returning to step/operation 1608, in some embodiments, if the requested data matching the search features is in proximity or adjacent to the retrieve procedure cue neuron search location, then at step/operation 1612, the computing entity fetches the requested data. In some embodiments, at step/operation 1614, the computing entity increases the memory strength of the fetched data. In some embodiments, at step/operation 1616, subsequent to step/operation 1614, the computing entity modifies the NoK based on a pattern of the search for the retrieve procedure cue neuron search location to ensure future access to that region (e.g., of the fetched data) is incrementally faster and/or more accessible. In particular, the computing entity may modify the NoK structure and association weights of cue neurons and/or data neurons for increased accessibility. In some embodiments, modifying the NoK comprises modifying neuron pathways such that one or more neurons may be bypassed in an access path while trying to reach specific neurons. In some embodiments, modifying the NoK comprises modifying association weights to give higher search priority to certain neuron pathways.

In some embodiments, the computing entity also modifies the NoK based on a pattern of the search for the retrieve procedure cue neuron search location, if the search limit value has been reached at step/operation 1606.

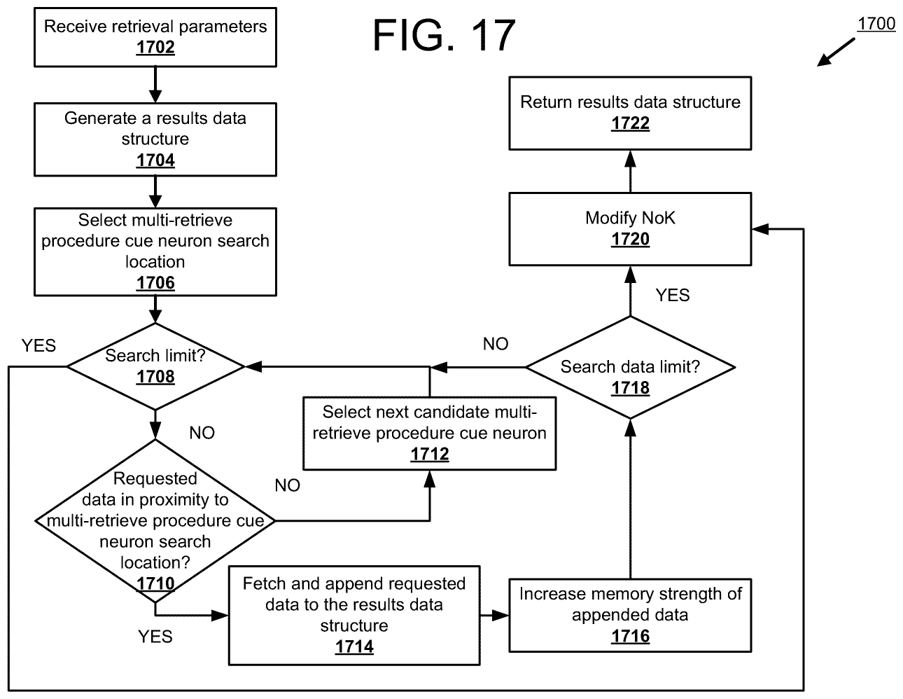

Multi-Load/Retrieve: Referring to FIG. 17 a flowchart of an example method for retrieving a plurality of data items from an intelligent digital memory system comprising memory, such as storage subsystem 1108, non-volatile memory 1210, volatile memory 1215, volatile memory 1322, and non-volatile memory 1324 is depicted. The flowchart depicted in FIG. 17 may correspond to retrieval operations performed by a processing element 1205 or a processing element 1308, in memory, or a combination of both, e.g., data analysis computing entity 1106 and client computing entity 1102 as they execute intelligent digital memory system retrieval operations in their respective volatile and/or non-volatile memory.

In some embodiments, method 1700 begins at step/operation 1702 when a computing entity receives retrieval parameters comprising search features associated with a data request, a search limit value, gist information, and a data limit value. In some embodiments, at step/operation 1704, the computing entity generates a results data structure for populating with search data. In some embodiments, at step/operation 1706, the computing entity determines a multi-retrieve procedure cue neuron search location for retrieving requested data items comprising a starting point where a search will originate by selecting a multi-retrieve procedure cue neuron search location in an NoK based on the search features. The starting point may be selected based on a comparison of the search features with key pre-identified cue neurons.

In some embodiments, at step/operation 1708, the computing entity compares a number of performed searches for the multi-retrieve procedure cue neuron search location with the search limit value. In some embodiments, if the number of searches does not reach the search limit value, then at step/operation 1710, the computing entity determines if requested data matching the search features is in proximity or adjacent to the multi-retrieve procedure cue neuron search location. In some embodiments, if the requested data is not in proximity or adjacent to the multi-retrieve procedure cue neuron search location, then at step/operation 1712, the computing entity selects a next candidate cue neuron in the NoK neighbor for a potential next search step based on NoK connectivity and the gist information.

Returning to step/operation 1710, in some embodiments, if the requested data matching the search features is in proximity or adjacent to the multi-retrieve procedure cue neuron search location, then at step/operation 1714, the computing entity fetches and appends the requested data as a data element to the results data structure. In some embodiments, at step/operation 1716, the computing entity increases the memory strength of the appended data. In some embodiments, at step/operation 1718, the computing entity compares the size of data inserted in the results data structure with the data limit value. In some embodiments, if the data limit value has not been exceeded, the computing entity continues to step/operation 1708 to search for and append additional data to the results data structure such that a plurality of data elements matching the search feature may be retrieved. Otherwise, in some embodiments, at step/operation 1720, the computing entity modifies the NoK based on a pattern of the search for the multi-retrieve procedure cue neuron search location to ensure future access to that region (e.g., of fetched data) is incrementally faster and/or more accessible. In particular, the computing entity may modify the NoK structure and association weights of cue neurons and/or data neurons for increased accessibility. In some embodiments, modifying the NoK comprises modifying neuron pathways such that one or more neurons may be bypassed in an access path while trying to reach specific neurons. In some embodiments, modifying the NoK comprises modifying association weights to give higher search priority to certain neuron pathways. In some embodiments, at step/operation 1722, the computing entity returns the results data structure as output of the method 1700.

Returning to step/operation 1708, in some embodiments, if the search limit value has been reached, then at step/operation 1720, the computing entity modifies the NoK based on a pattern of the search for the multi-retrieve procedure cue neuron search location. In some embodiments, at step/operation 1722, the computing entity returns the results data structure as output.

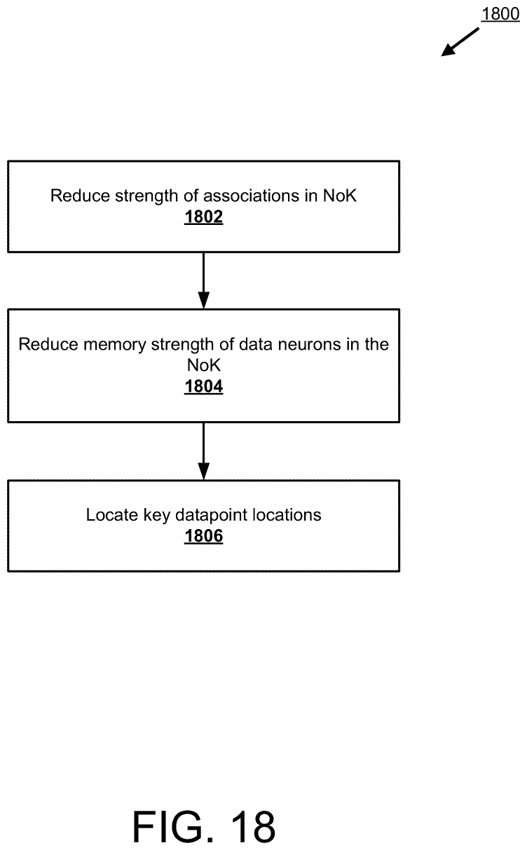

Retention: Referring to FIG. 18 a flowchart of an example method for aging an intelligent digital memory system comprising memory, such as storage subsystem 1108, non-volatile memory 1210, volatile memory 1215, volatile memory 1322, and non-volatile memory 1324 is depicted. The flowchart depicted in FIG. 18 may correspond to retention operations performed by a processing element 1205 or a processing element 1308, in memory, or a combination of both, e.g., data analysis computing entity 1106 and client computing entity 1102 as they execute intelligent digital memory system retention operations in their respective volatile and/or non-volatile memory.

In some embodiments, method 1800 begins at step/operation 1802 when a computing entity reduces association strengths within an NoK. In some embodiments, at step/operation 1804, the computing entity reduces memory strength of data neurons in the NoK. The aforementioned steps/operations comprise and aging effect that counteracts the strengthening (positive feedback) effect during other memory operations. In some embodiments, at step 1806, the computing entity analyzes the NoK to search for and locate key data point locations in the NoK for potential rapid retrieval. Locating the key data points may further comprise marking the key data point locations in the NoK and assigning a score to each data point at the key data point locations.

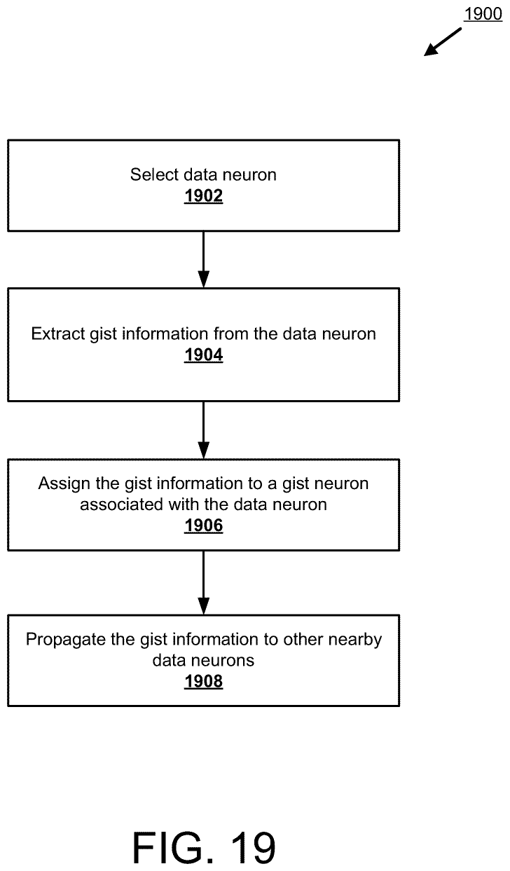

Gist Extraction: Referring to FIG. 19 a flowchart of an example method for extracting gist information from an intelligent digital memory system comprising memory, such as storage subsystem 1108, non-volatile memory 1210, volatile memory 1215, volatile memory 1322, and non-volatile memory 1324 is depicted. The flowchart depicted in FIG. 19 may correspond to gist information retrieval operations performed by a processing element 1205 or a processing element 1308, in memory, or a combination of both, e.g., data analysis computing entity 1106 and client computing entity 1102 as they execute intelligent digital memory system gist information retrieval operations in their respective volatile and/or non-volatile memory.

In some embodiments, method 1900 begins at step/operation 1902 when a computing entity selects a data neuron for which gist information is to be extracted from. A data neuron associated with a gist neuron having least confidence may be selected for extraction.

In some embodiments, at step/operation 1904, the computing entity extracts gist information from the data neuron. In some embodiments, at step/operation 1906, the computing entity assigns the gist information to the data neuron's gist neuron. In some embodiments, at step/operation 1908, the computing entity propagates the gist information to nearby data neurons (e.g., neighbors of the data neuron) based on an assumption that similar data will co-exist in the NoK due to spatial feature-based data insertion and re-organization. The gist information may be propagated based on a distance weighted graph traversal algorithm with a limit on number of propagations.

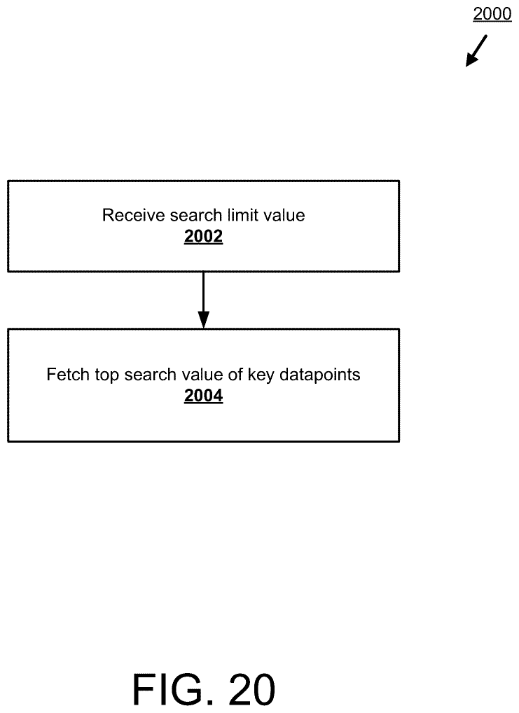

Key Data Point Fetch: Referring to FIG. 20 a flowchart of an example method for fetching key data points in an intelligent digital memory system comprising memory, such as storage subsystem 1108, non-volatile memory 1210, volatile memory 1215, volatile memory 1322, and non-volatile memory 1324 is depicted. The flowchart depicted in FIG. 20 may correspond to key data point fetch operations performed by a processing element 1205 or a processing element 1308, in memory, or a combination of both, e.g., data analysis computing entity 1106 and client computing entity 1102 as they execute intelligent digital memory system key data point fetch operations in their respective volatile and/or non-volatile memory. The key data points at a particular instance may be kept pre-determined during retention operations.

In some embodiments, method 2000 begins at step/operation 2002 when a computing entity receives a search limit value. In some embodiments, at step/operation 2004, the computing entity fetches top key data points by searching an NoK for key data points based on their scores within the search limit value. Key data points within the NoK may be marked and assigned scores.

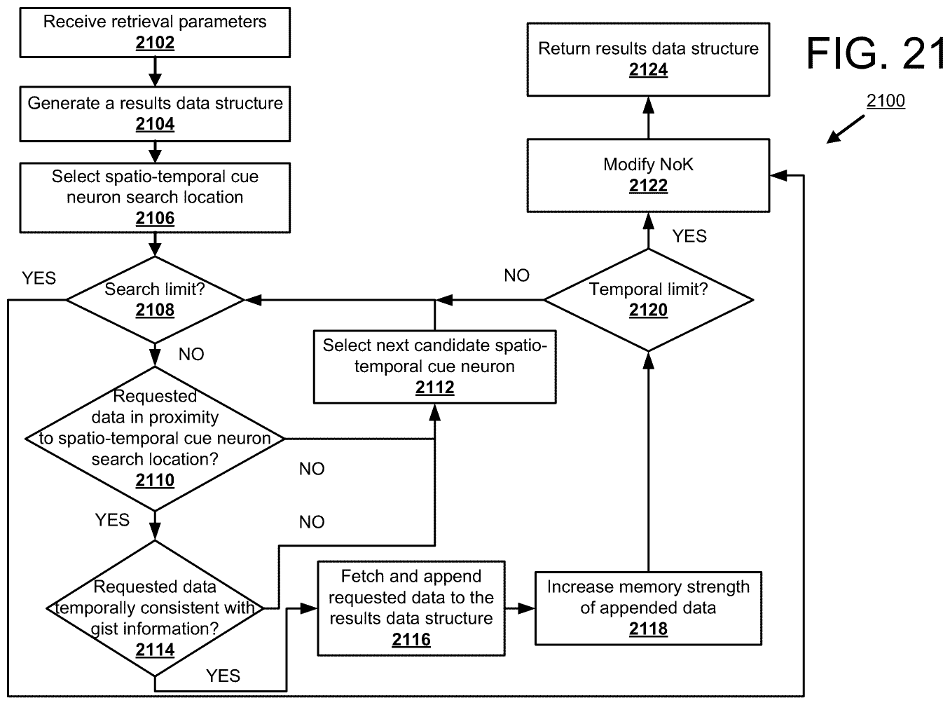

Spatio-Temporal Search: Referring to FIG. 21 a flowchart of an example method for performing a spatio-temporal search operation on an intelligent digital memory system comprising memory, such as storage subsystem 1108, non-volatile memory 1210, volatile memory 1215, volatile memory 1322, and non-volatile memory 1324 is depicted. The flowchart depicted in FIG. 21 may correspond to spatio-temporal search operations performed by a processing element 1205 or a processing element 1308, in memory, or a combination of both, e.g., data analysis computing entity 1106 and client computing entity 1102 as they execute intelligent digital memory system spatio-temporal search operations in their respective volatile and/or non-volatile memory. According to various embodiments of the present disclosure, data neurons may be stored based on temporal connectivity, which allows for fetching of multiple data neurons with a specific temporal relation/distance.

In some embodiments, method 2100 begins at step/operation 2102 when a computing entity receives search parameters comprising search features associated with a spatio-temporal data request, a search limit value, gist information, a temporal limit value, and a near or far value. In some embodiments, at step/operation 2104, the computing entity generates a results data structure for populating with search data. In some embodiments, at step/operation 2106, the computing entity determines a spatio-temporal cue neuron search location for retrieving spatio-temporal requested data items comprising a starting point where a search will originate by selecting a spatio-temporal cue neuron search location in an NoK based on the search features. The starting point may be selected based on a comparison of the search features with key pre-identified cue neurons.

In some embodiments, at step/operation 2108, the computing entity compares a number of performed searches for the spatio-temporal cue neuron search location with the search limit value. In some embodiments, if the number of searches does not reach the search limit value, then at step/operation 2110, the computing entity determines if requested data matching the search features is in proximity or adjacent to the spatio-temporal cue neuron search location based on the search features. In some embodiments, if the requested data is not in proximity or adjacent to the spatio-temporal cue neuron search location, then at step/operation 2112, the computing entity selects a next candidate cue neuron in the NoK neighbor for a potential next search step based on NoK connectivity and the gist information. The computing entity may iteratively search candidate cue neurons until the search limit value is reached (step/operation 2108) or until the requested data matching the search features is in proximity or adjacent to the spatio-temporal cue neuron search location (step/operation 2110).

Returning to step/operation 2110, in some embodiments, if the requested data matching the search features is in proximity or adjacent to the spatio-temporal cue neuron search location, then at step/operation 2114, the computing entity determines whether the requested data is temporally consistent with the gist information. The determination comprises determining if the near or far value indicates “near” or “far.” If “near,” then the requested data is determined whether it is within a distance of the temporal limit value from other elements in the results data structure. Otherwise, if “far,” then the requested data is determined whether it is at least a distance of the temporal limit value from other elements in the results data structure.

In some embodiments, at step/operation 2116, the computing entity fetches and appends data in proximity or adjacent to the spatio-temporal cue neuron search location as a data element to the results data structure thereby forming a sequence of data for fetching. In some embodiments, at step/operation 2118, the computing entity increases the memory strength of the appended data. In some embodiments, at step/operation 2120, the computing entity compares the size of data stored in the data structure with the temporal limit value. In some embodiments, if the temporal limit value has not been exceeded, the computing entity continues to step/operation 2108 to search for and append additional data to the results data structure such that a sequence of data may be retrieved. Otherwise, in some embodiments, at step/operation 2122, the computing entity modifies the NoK based on a pattern of the search for the spatio-temporal cue neuron search location to ensure future access to that region (e.g., of the fetched data) is incrementally faster and/or more accessible. In particular, the computing entity may modify the NoK structure and association weights of cue neurons and/or data neurons for increased accessibility. In some embodiments, modifying the NoK comprises modifying neuron pathways such that one or more neurons may be bypassed in an access path while trying to reach specific neurons. In some embodiments, modifying the NoK comprises modifying association weights to give higher search priority to certain neuron pathways. At step/operation 2124, the computing entity returns the results data structure as output of the method 2100.

Returning to step/operation 2108, in some embodiments, if the search limit value has been reached, then at step/operation 2122, the computing entity modifies the NoK based on a pattern of the search for the spatio-temporal cue neuron search location. In some embodiments, at step/operation 2124, the computing entity returns the results data structure as output.

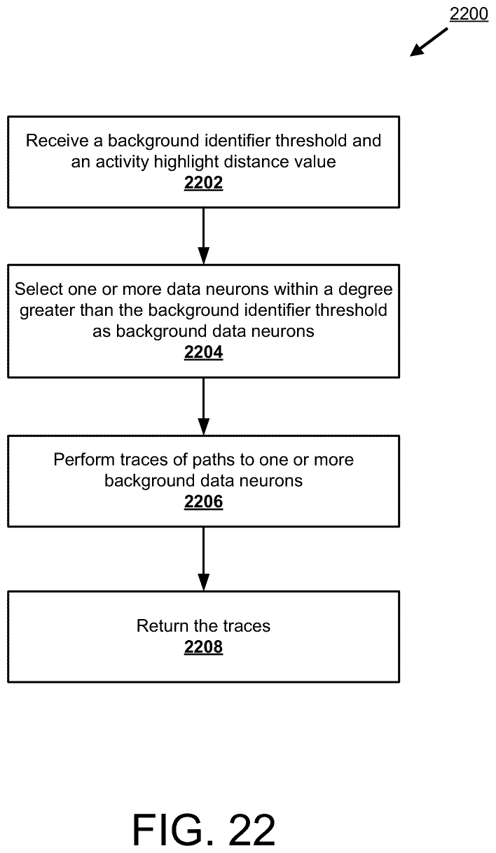

Activity Detection: Referring to FIG. 22 a flowchart of an example method for detecting activity of an intelligent digital memory system comprising memory, such as storage subsystem 1108, non-volatile memory 1210, volatile memory 1215, volatile memory 1322, and non-volatile memory 1324 is depicted. The flowchart depicted in FIG. 22 may correspond to activity detection operations performed by a processing element 1205 or a processing element 1308, in memory, or a combination of both, e.g., data analysis computing entity 1106 and client computing entity 1102 as they execute intelligent digital memory system activity detection operations in their respective volatile and/or non-volatile memory.

In some embodiments, method 2200 begins at step/operation 2202 when a computing entity receives a background identifier threshold and an activity highlight distance value. In some embodiments, at step/operation 2204, the computing entity selects one or more data neurons from an NoK within a degree greater than the background identifier threshold as background data neurons. In some embodiments, at step/operation 2206, for each background data neuron, the computing entity performs traces of different unique paths back to the background data neuron within the activity highlight distance value of hops. In some embodiments, at step/operation 2208, the computing entity returns the traces comprising referential activities as output.

### Example Intelligent Digital Memory System Parameters

The disclosed intelligent digital memory system may comprise parameters that can modulate its behavior. For example, the disclosed intelligent digital memory system may comprise (1) learnable parameters that may change throughout the system's lifetime guided by online reinforcement-learning and aging and (2) hyperparameters that may be set during system initialization and changed infrequently.

The following describes a set of learnable parameters and a set of system-level hyperparameters which govern functionality and behavior of an intelligent digital memory system according to various embodiments of the present disclosure.

Learnable Parameters: Learnable parameters may be adjusted during intelligent digital memory system operations through reinforcement online learning and an aging process. The reinforcement may come from data access patterns, search success/failure, and gist confidence values. The number of learnable parameters can also change after each operation. Examples of learnable parameters include an adjacency matrix for an entire NoK graph, memory strength, and gist composition.

The adjacency matrix may comprise a data neuron and cue neuron weighted graph as well as an NoK spatial graph and an NoK temporal graph. A weighted graphs for NoK may directly impact data search efficiency (time and energy). Hence, the elements of a graph adjacency matrix may be considered as learnable parameters. NoK spatial graph may comprise an n x n matrix denoting spatial connectivity of n neurons in the NoK. Changing the values of the NoK spatial graph may result in graph structure alteration leading to a change in NoK navigation and search behavior. NoK temporal graph may comprise an n x n matrix capturing the temporal linkage between neurons. Changes to the NoK temporal graph may indicate alternation of temporal knowledge stored in the memory.

Memory strength for data neurons may be considered as learnable parameters. The quality and size of a data neuron may depend on its memory strength. Memory strength may comprise a n_{d} dimensional vector where n_{d} represents the number of data neurons in the NoK. A higher value may indicate more data resolution and stronger perceived importance of data. Memory strength of data neurons may jointly dictate space-utilization, transmission efficiency and retrieved data quality.

Gist composition may comprise a n_{g} dimensional vector of pairs where n_{g} represents the total number of gist neurons in the NoK. Elements of gist compositions may comprise gist-val and gist-confidence. Gist-val may represent high-level information of surrounding data and gist-confidence may represent a projected confidence of the gist-val information.

Hyperparameters: Hyperparameters may affect memory organization and be used to adjust or tune the behavior of an intelligent digital memory system in terms of how the learnable parameters are adjusted and how each memory operation is performed. In some embodiments, each memory hive may be associated with specific hyperparameters. Examples of hyperparameters of an intelligent digital memory system include memory strength modulation factor (δ₁), memory decay rate (δ₂), maximum memory strength (δ₃), association strengthening step-size (η₁), association weight decay rate (η₂), association pull-up hastiness (η₃), cue neuron matching metric for store (Λ₁i), cue neuron matching metric for load (Λ₂), degree of allowed impreciseness (φ), initial association weight (ε₁), minimum association weight (ε₂), store effort limit (π₁), retrieve effort limit (π₂), locality crossover (ω), frequency of retention procedure (ξ), gist confidence threshold (γ), temporal Fusion (χ), spread Limit (θ₁), spread Decay (θ₂), and compression techniques.

Memory strength modulation factor (δ₁) may comprise a hyperparameter that determines step-size for controlling data neuron memory strength inside an NoK in response to specific memory access patterns. The memory strength modulation factor (δ₁) hyperparameter may be used during store and retrieve operations of an intelligent digital memory system.

Memory decay rate (δ₂) may comprise a hyperparameter used to control the rate at which data neurons loses memory strength and features due to aging during a retention operation of an intelligent digital memory system.

Maximum memory strength (δ₃) may comprise a hyperparameter that determines a maximum memory strength a data neuron can attain. The maximum memory strength (δ₃) hyperparameter may be used during store and retrieve operations of an intelligent digital memory system.

Association strengthening step-size (η₁) may comprise a hyperparameter that determines step-size for increasing spatio-temporal edge strengths or association weights inside an NoK in response to specific access patterns. The association strengthening step-size hyperparameter may be used during store and retrieve operations of an intelligent digital memory system.

Association weight decay rate (η₂) may comprise a hyperparameter that determines step size for decreasing association weights inside the NoK to control a rate of decay of spatio-temporal edge strengths due to aging. The association weight decay rate (η₂) hyperparameter may be used during a retention operation of an intelligent digital memory system.

Association pull-up hastiness (η₃) may comprise a hyperparameter used to control the momentum with which neurons are re-adjusted based on data access and search patterns during store and retrieve operations of an intelligent digital memory system. The association pull-up hastiness (η₃) hyperparameter may determine the haste with which the accessibility of a given neuron is increased in response to a specific access pattern.

Cue neuron matching metric for store (Λ₁) may comprise a list of floating-point values in a range [0,100] representative of similarity thresholds for cues during a store operation. Each value may correspond to a particular cue level and denotes a minimum threshold beyond which a feature match during store operation is considered to be a success. For example, η₁={λ₁₁, λ₁₂, . . . λ₁₁}, for a system with l different cue levels.

Cue neuron matching metric for load (Λ₂) may comprise a list of floating-point values in a range [0,100] representative of similarity thresholds for cues during a retrieve operation. Each value may correspond to a particular cue level and denotes a minimum threshold beyond which a feature match during retrieve/multi-retrieve operations are considered to be a success. For example, Λ₂={λ₂₁, λ₂₂, . . . λ₂₁}, for a system with l different cue levels.

Degree of allowed impreciseness (φ) may comprise a hyperparameter that determines a minimum value of data neuron strength during retention operation of an intelligent digital memory system. The degree of allowed impreciseness (φ) hyperparameter may limit the amount of data feature which is allowed to be lost due to memory strength decay during aging. Setting φ=0 may enable data neuron deletion, which completely removes data if the need arises. This degree of allowed impreciseness (φ) hyperparameter may be used during a retention operation of an intelligent digital memory system.

Initial association weight (ε₁) may comprise a hyperparameter that determines an initial association weight of a newly formed association during store and retrieve operations of an intelligent digital memory system.

Minimum association weight (ε₂) may comprise a hyperparameter that determines a minimum allowed edge weight for limiting decay of an association weight beyond a certain point during retention operation of an intelligent digital memory system. For example, setting ε₂=0 may deletion of associations.

Store effort limit (π₁) may comprise a hyperparameter that determines a limit of amount of effort/energy utilized during the search phase of a store operation of an intelligent digital memory system. For example, setting π₁=−1 may enable an infinite limit.

Retrieve effort limit (π₂) may comprise a hyperparameter that determines a limit of amount of effort/energy utilized during the search phase of retrieve/multi-retrieve operations of an intelligent digital memory system. For example, setting (π₂)=−1 may enable an infinite limit.

Locality crossover (ω) may comprise a Boolean flag that enables rigid locality formation for localizing similar data neurons during store, retrieve, and multi-retrieve operations of an intelligent digital memory system.

Frequency of retention procedure (ξ) may comprise a hyperparameter used to control a frequency at which a retention operation is invoked by an intelligent digital memory system. The retention operation of the intelligent digital memory system may create an aging effect. The frequency of retention procedure (ξ) hyperparameter may be a positive integer denoting a number of normal operations to be performed before the retention operation is called once. A lower value may increase dynamism.

Gist confidence threshold (γ) may comprise a hyperparameter of a gist confidence value beyond which it is considered correct by an intelligent digital memory system during store, retrieve, and multi-retrieve operations of an intelligent digital memory system.

Temporal fusion (χ) may comprise a Boolean flag which enables an NoK search process to utilize both spatial edges and temporal edges (if χ=1). If χ=0, then only the spatial connections may be used for the NoK search process. This hyperparameter may be used during a store operation of an intelligent digital memory system.

Spread limit (θ₁) may comprise a hyperparameter used to control an extent of gist information spread during gist extraction performed by a computing entity comprising an intelligent digital memory system.

Spread decay (θ₂) may comprise a hyperparameter used to control intensity of gist information spread during gist extraction performed by a computing entity comprising an intelligent digital memory system.

A compression technique hyperparameter may determine an algorithm for data compression utilized to adjust data neuron size, e.g., for each memory hive, based on perceived importance during retention operation of an intelligent digital memory system. For example, the compression technique hyperparameter may specify a Joint Photographic Experts Group (JPEG) compression for an image hive.

### Example Learning Process

The aforementioned learnable parameters, governing the behavior of a NoK used by the disclosed intelligent digital memory system, may be updated based on feedback from different memory operations. The disclosed learning process draws inspiration from online reinforcement learning and aims to (1) increase memory search speed by learning the right NoK organization based on the memory access pattern and (2) reduce space requirement while maintaining data retrieval quality and application performance, which may be achieved by learning the granularity (details) at which each data neuron should be stored given data access-pattern and system requirements.

In some embodiments, the learnable parameters (Θ) may comprise A, an adjacency matrix for the entire NoK graph and M, a vector where each element comprises a corresponding neuron's memory strength. For an NoK with n neurons (DNs and CNs):

$$A = [ \begin{matrix}{a}_{11} & {a}_{12} & {a}_{13} & … & {a}_{1 n} \\ {a}_{21} & {a}_{22} & {a}_{23} & … & {a}_{2 n} \\ … & … & … & … & … \\ {a}_{n 1} & {a}_{n 2} & {a}_{n 3} & … & {a}_{n n}\end{matrix} ]$$

$$M = [ \begin{matrix}{s}_{1} & {s}_{2} & {s}_{3} & {s}_{4} & {s}_{5} & … & {s}_{n}\end{matrix} ]$$

For ∀ₛ_{ᵢ}∈M, sᵢ∈[φ, δ₃] if the neuron i is a data neuron and sᵢ=0 if the neuron i is a cue neuron. Where φ represents the degree of allowed impreciseness hyperparameter and δ₃ represents the maximum memory strength hyperparameter, as disclosed above.

According to various embodiments of the present disclosure, a learning process is embedded in store and retrieve operations of the disclosed intelligent digital memory system. In some embodiments, store and retrieve operations may comprise a search for a suitable cue neuron in the NoK which will serve as a reference point for either inserting new data or retrieving a data neuron. The search may be performed with the help of associated features or search cues. In some embodiments, the search comprises a limited and weighted breadth-first search (e.g., Algorithm 2 in the Appendix of Example Algorithms). The outcome of the search may comprise a traversal order Y^{t}={N₁^{t}, N₂^{t}, N₃^{t}, . . . , N_{f}^{t}}, where each Nᵢ^{t}∈Y^{t} is the index of a neuron in the NoK which have been visited during the search process. The neuron N_{f}^{t} may be considered as the neuron which has been accessed at the end of the search (e.g., the reference point). Assume that the path from N₁^{t} to N_{f}^{t} in Y^{t} be Y^{p}, and Y^{p}={N₁^{o}, N₂^{p}, N₃^{p}, . . . , Nₖ^{p}} where N₁^{t}=N₁^{o} and Nₜ^{t}=Nₖ^{p}. Then, both Y^{t} and Y^{p} may comprise the feedback on the basis of which the NoK learnable parameters are adjusted. In a best case, the length (Y^{t}) can be minimum 2 for a search. Hence, based on the search outcome Y^{t}, Θ may be modified such that the probability(length (Y^{t})=2|C, Θ) can be maximized. During a store operation, extra neurons may also get added to the NoK. This will lead to the addition of more parameters (that is, parameter expansion due to neuron addition).

### Learning from Operation Feedback

Updated parameters Θ′=(A′, M′) may be determined based on Y^{t} and Y^{p}. If length (Y^{p})>2, ΔA may comprise a zero matrix of dimension (n, n) with the following exceptions: (i) ΔA[N_{k-τ}^{p}][Nₖ^{p}]=ε₁ and (ii) ΔA[Nₖ^{p}][N_{k-τ}^{p}]=ε₁. Here τ=min(k−1, η₃+1). If length (Y^{p})=2, ΔA may comprise a zero matrix with the following exceptions: (i) ΔA[N₀^{p}][N₁^{p}]=η₁ and (ii) ΔA[N₁^{p}][N₀^{p}]=η₁. With the ΔA defined, the updated parameters may be determined as follows: (A′)=(A)+ΔA. Here, ε₁ may represent the initial association weight hyperparameter, η₁ may represent the association strengthening step-size hyperparameter, and 113 may represent the association pull-up hastiness hyperparameter, as disclosed above.

ΔM may be determined based on based on Y^{p}. If D={d₁, d₂, d₃, . . . dₗ} are the indices of data neurons associated with the cue neuron Nₖ^{p}. Then, ΔM may comprise a zero vector of dimension n with the following exceptions: ∀_{d}_{ᵢ}∈D,ΔM[dᵢ]=min(f¹(δ₁),δ₃−(M[dᵢ])). Here δ₁ may represent the memory strength modulation factor hyperparameter, and δ₃ may represent the maximum memory strength allowed hyperparameter. The function f¹ may be application dependent. For example, f¹ can be f¹(x)=x. With the ΔM defined, the updated parameters: M′=M+ΔM may be determined. In some embodiments, no parameter is changed in the case of a failed retrieval attempt.

### Parameter Expansion Due to Neuron Addition

In case of a store operation, if new cue neurons and data neurons are added to an NoK, then the previously computed Θ″ may be expanded to Θ″=(A″, M″) for accommodating the parameters of the new neurons. N′={N′₁, N′₂, . . ., N′₀} may be the indices of new neurons added to the NoK. Θ″ may be computed as follows: (1) additional o rows and columns may be added to A′ to generate A″. Each of the new entries (learnable parameters) in the matrix may be zero with the following exceptions: ∀N′ᵢ∈N′, if N′ᵢ is to be associated with neurons AN¹={AN₁ⁱ, AN₂ⁱ, . . . , AN_{q}ⁱ}, then ∀ANⱼⁱ∈ANⁱ, A″[N′ⱼ][ANⱼⁱ]=ε₁ and A″[ANⱼⁱ][N′ⱼ]=ε₁ and (2) the dimension of vector M′ may be expanded by o to form M″. ∀i∈[n+1, n+0] M″[i]=δ₃ if i corresponds to a data neuron, and M″[i]=0 if i corresponds to a cue neuron.

### Example Aging Process

According to various embodiments of the present disclosure, retention operation of an intelligent digital memory system comprises an aging effect that reduces memory strength of all data neurons and decreases the weight of all associations. As a data neuron's strength decreases, the intelligent digital memory system may start compressing data gradually. This compression may lead to data granularity (details) loss but frees up space for more relevant data. As such, a tug-of-war between aging and positive reinforcements may be created during store and retrieve operations of the intelligent digital memory system.

### Parameter Adjustment Due to Retention

Before retention, learnable parameters may be Θ=(A, M). ΔA of dimension (n, n) may be determined such that ΔA[i][j]=min(η₂, A[i][j]−ε₂) for i,j∈[1, n]. ΔM of dimension n ma be computed such that ΔM[i]=min(f²(δ₂),M[i]−φ) for i∈[1, n]. The function f² may be f²(x)=x or a more complex function depending on computing application requirement. Updated parameters Θ′=(A′, M′) may be computed by A′=A−ΔA and M′=M−ΔM.

### Parameter Freezing

After a retention operation, some of the parameters comprising Θ′ may become frozen if they reach a certain value. For example, if the entries A′[i][j] and A′[j][i] reach zero, then the parameters association may be considered dead and remain frozen until the association is revived with feedback from a future memory operation. If an entry M′[i], where i corresponds to a data neuron reaches zero, then the data neuron may be considered dead and the parameter M′[i] is frozen.

### Example Spatio-Temporal Operation Algorithms

Example algorithms for performing store, retrieve, and retention operations in an intelligent digital memory system are disclosed and may be further understood with reference to the Appendix of Example Algorithms.

Store: Data may be stored in an NoK of the disclosed intelligent digital memory system. The data may be organized inside the NoK based on spatial-temporal relevance with respect to nearby data units. From a high level, based at least on input data features and cues, an entry point into the NoK is selected. Based on a traversal algorithm, a location where the input data should optimally reside can be decided. The NoK is modified to reflect the new insertion and other efficiency related adjustments.

A store operation performed by a computing entity comprising an intelligent digital memory system is described with reference to a combination of one or more of Algorithms 1, 2, 3, and 4.

In Algorithm 1, a “STORE” procedure is disclosed. MEM may comprise an NoK of an intelligent digital memory system where data is to be stored in an intelligent digital memory system. D may comprise data to be stored. C may comprise a set of cues associated with D. HP may comprise hyperparameters for the MEM. Before new data can be stored, the intelligent digital memory system checks if enough space exists in MEM to insert D (lines 2 and 3). In the event of a memory space shortage in MEM, a “RETENTION” procedure (e.g., Algorithm 7) may be invoked to compress less accessed data neurons (line 2-3). If the NoK is empty, then for the first insertion (lines 4 and line 5), the NoK graph may be generated with a seed organization comprising a generation of a new cue neuron for each cue in C, where the new cue neurons may be connected depending on their level. A data neuron for D may be generated and appended at the end. If the NoK is not empty, then the system may search for a suitable location to insert the input data.

A level-n cue neuron in the NoK is selected to serve as the starting point of an NoK traversal process. Entry point (Loc_Cₙ) may be selected as the level-n cue neuron from where the search is to begin and Flag_Cₙ indicates whether a similarity between C→level_n_cue and Loc_Cₙ is more than X, (hyperparameter). Next, a search in the NoK is performed starting from Loc_Cₙ for finding a suitable location for inserting D (line 8). In line 8, a “SEARCH” procedure (e.g., Algorithm 2) is invoked to find an optimal position for inserting D.

HP→π₁ may comprise a hyperparameter that limits the search effort. The suitable location for inserting the data neuron may be represented as a level-1 cue neuron around which the data are to be inserted. The variable access_Path may comprise a list of neurons in the path from Loc_Cₙ to the selected suitable level-1 cue neuron (access_Path[−1] or the last element in the list access_Path). Flag_C₁ may indicate whether the similarity between C→level_1_cue and the cue-neuron access_Path[−1] is more than λ₁ (hyperparameter). The data D may be inserted (or merged with an existing data neuron) around access_Path[−1].

In Algorithm 2, a “SEARCH” procedure is disclosed. MEM may comprise a memory hive where a search operation is performed, C may comprise a set of cues provided by the user for the operation, HP may comprise a set of hyperparameters for MEM, ep may comprise a level-n cue neuron (n=2) selected as the starting/entry point of a search, and limit may comprise a search effort limit for the search operation. The search procedure may comprise a limited-weighted version of a breadth-first-search (BFS) where neuronQueue may comprise a BFS Queue, bestCandidate may comprise a level-1 cue deemed to be the best search candidate at a given point of time, and bestCandidate_Sim may comprise a similarity between the bestCandidate and C→level_1_cue. The visited list may keep track of neurons already visited, and traversalMotion list may keep track of the order in which each neuron is visited along with their parent neuron. While the neuronQueue is not empty (line 4) and the number of neurons traversed so far is less than limit, the search continues.

If the hyperparameter HP→ω=1, then paths blocked by level-n cue neurons may be ignored to restrict the search within a specific locality (sub-graph) of the NoK graph (line 9). During each step of the search, a new neuron may be encountered and if it is a level-1 cue neuron, then it is compared with C→level_1_cue. If the similarity of the comparison (sim) between the neuron and the C→level_1_cue is greater than HP→λ₁ (hyperparameter), then a good match is found. In this case, the path traversed to access this level-1 cue neuron (neuron) is extracted from traversalMotion (line 15) and returned from the procedure along with a flag value of 1 indicating that a good match was found (line 16).

After visiting each neuron, all the adjacent neurons of the visited neurons are enqueued in descending order of their corresponding association weights (lines 20-25). If a level-1 cue neuron with sim>HP→λ₁ is not found at the end of the search, then the best candidate level-1 cue neuron encountered so far is considered. The path traversed to access this level-1 cue neuron (bestCandidate) is extracted from the traversalMotion (line 26) and returned from the procedure along with a flag value of 0 indicating that a good match was not found (line 27).

A “LEARN STORE” procedure is described in Algorithm 3. Algorithm 3 is invoked in Algorithm 1, at line 9, where access_Path and Flag_C₁ from Algorithm 2 and Flag_Cₙ from Algorithm 1 are part of the inputs to Algorithm 3. In Algorithm 3, the NoK is modified based on insertion location search results. Four different scenarios may arise based on the values of Flag_Cₙ and Flag_C₁.

If Flag_Cₙ and Flag_C₁ are both equal to ‘1,’ then it can be inferred that the entry point level-n cue neuron has a good match with C→level_n_cue and the level-1 cue neuron selected (access_Path[−1]) at the end of the SEARCH procedure (Algorithm 2) also has a good match with C→level_1_cue, and as such, may indicate that the data D or very similar data already exists in the NoK and is connected to access_Path[−1]. The data-neuron (based on HP→δ₁ and HP→δ₃) connected to access_Path[−1] is strengthened and the accessibility of the level-1 cue neuron access_Path[−1] in the NoK is increased by performing an “INC_ACCESSIBILITY” procedure (Algorithm 4).

If Flag_Cₙ=‘0’ and Flag_C₁=1,' then it can be inferred that the graph search entry point level-n neuron does not have a good match with C→level_n_cue but the level-1 cue selected (access_Path[−1]) at the end of the SEARCH procedure has a good match with C→level_1_cue, and as such, indicates that the data D or very similar data already exists in the NoK and is connected to access_Path[−1] but no cue neuron for C→level_n_cue exists in the NoK. The data-neuron connected to access_Path[−1] is strengthened (based on HP→δ₁ and HP→δ₃), a new level-n cue neuron (newCN) for C→level_n_cue is created, newCN is connected with access_Path[−1], and the accessibility of the level-1 cue neuron access_Path[−1] in the NoK is increased using by performing the INC_ACCESSIBILITY procedure (Algorithm 4). Such steps may be representative of data neuron merging.

If Flag_Cₙ‘1’ and Flag_C₁=‘0’, then it can be inferred that the graph search entry point level-n neuron has a good match with C→level_n_cue but the level-1 cue selected (access_Path[−1]) at the end of the SEARCH procedure does not have a good match with C→level_1_cue. A new level-1 cue neuron (newCN) is created for C→level_1_cue, a new data neuron (newDN) is created for D, newDN and newCN are connected, newCN is connected with the access_Path[−1], and the accessibility of the level-1 cue neuron access_Path[−1] in the NoK is increased using the INC ACCESSIBILITY procedure (Algorithm 4). New connections may be initialized with association strength HP→ε₁.

If Flag_Cₙ=‘0’ and Flag_C₁=‘0’, then it can be inferred that the graph search entry point level-n neuron does not have a good match with C→level_n_cue and the level-1 cue neuron selected (access_Path[−1]) at the end of the SEARCH procedure also does not have a good match with C→level_1_cue. A new level-1 cue neuron (newCN_l₁) is created for C→level_1_cue, a new level-n cue neuron (newCN_lₙ) is created for C→level_n_cue, a new data neuron (newDN) is created for D, newCN_lₙ is connected with newCN_l₁, newCN_l₁ is connected with newDN, newCN_lₙ is connected with access_Path[−1], and accessibility of the level-1 cue neuron access_Path[−1] in the NoK is increased using the INC_ACCESSIBILITY procedure (Algorithm 4). New connections may be initialized with association strength HP→ε₁.

The INC_ACCESSIBILITY procedure (Algorithm 4) may increase the accessibility of a neuron at the end of the access_Path (access_Path[−1]). Based on the current location of access_Path[−1], one of two possible rules is selected and used for increasing the accessibility of access_Path[−1].

1. Pull up: If len(access_Path)>2, then the level-1 cue neuron access_Path[−1] is connected with an ancestor neuron in the access_Path depending on the len(access_Path) and HP→η₃. This rule may allow future searches to bypass one or more neurons in the access_Path while trying to reach access_Path[−1] from access_Path[0].

2. Strengthen: If len(access_Path)==2, then it implies that the level-1 cue neuron access_Path[1] is directly connected to the level-n cue neuron access_Path[0] which was also the starting point of the search. The association weight between access_Path[0] and access_Path[1] is increased (by HP→η₁) to give it a higher search priority (weighted BFS during the SEARCH procedure in Algorithm 2).

Retrieve: A “RETRIEVE” procedure performed by a computing entity comprising an intelligent digital memory system for retrieving data from an NoK is described with reference Algorithm 5. MEM may comprise the NoK from where data retrieval is attempted. C may comprise a set of search cues on the basis of which the data is to be retrieved. HP may comprise a set of hyperparameters for MEM.

If the number of neurons in MEM is 0, then NULL is returned indicating a failed retrieval. Otherwise, an entry point in the NoK (a level-n cue, Loc_Cₙ) best situated as a starting point for searching the desired data is located, the NoK is searched starting from Loc_Cₙ using the SEARCH procedure, and based on the search results, the desired data is retrieved if it exists and modify the NoK in light of the access using the “LEARN RETRIEVE” procedure (Algorithm 6).

Flag_Cₙ may indicate whether similarity between C→level_n_cue and Loc_Cₙ is more than λₙ (hyperparameter). HP→π₂ may comprise a hyperparameter that limits the search effort. Flag_C₁ may indicate whether similarity between C→level_1_cue and the cue-neuron access_Path[−1] is more than λ₁ (hyperparameter). If Flag_C₁=1, then a matching level-1 cue neuron (attached to the desired data) is found in the NoK. The access_Path may comprise a list of neurons in the path from Loc_Cₙ to the matching level-1 cue neuron (access_Path[−1] or the last element in the list access_Path). The retrieved data D (if exists) is returned at the end of the procedure (line 9).

A “LEARN_RETRIEVE” procedure is described with reference to Algorithm 6. The Access_Path and Flag_C₁ from the SEARCH procedure (Algorithm 2) are part of the inputs to the LEARN_RETRIEVE procedure. The LEARN_RETRIEVE procedure may be used by an intelligent digital memory system to modify an NoK based on search results (e.g., performed using the RETRIEVE procedure). Two different scenarios may arise based on the value of Flag_C₁.

1. If Flag_C₁=1, then it can be inferred that at the end of the SEARCH procedure a good match between C→level_1_cue and access_Path[−1] was found, which may indicate that the desired data is associated with the level-1 cue neuron access_Path[−1]. Hence, the memory strength of this desired data neuron DN is enhanced (based on HP→δ₁ and HP→δ₃), the accessibility of the level-1 cue neuron access_Path[−1] is increased, and a value for DN is returned.

2. If Flag_C₁=0, then NULL is returned because no matching level-1 cue was located and may indicate that the queried data does not exist in the memory or could not be located within the search effort limit (HP→π₂)

Retention: A retention operation performed by a computing entity comprising an intelligent digital memory system is described with reference to Algorithm 7. The intelligent digital memory system may allow an NoK to modify itself to effect aging. The strength of all the associations in the NoK may be decreased in line 5 (by π₂), and the memory strength of all the data neurons may be weakened in line 9 based on Equation 1.

dₛₜᵣ−new=max (└strength(d)*2^{-δ}^{₂}┘,φ) Equation 1

Equation 1 may comprise an exponential decay function, where δ₂ may refer to the memory decay rate hyperparameter and φ may refer to the degree of allowed impreciseness hyperparameter. Weakening a data neuron may lead to compression and data feature loss. If all the associated data neurons of a level-1 cue neuron die, then that cue neuron is also marked as dead and is bypassed during future searches. Hyperparameter HP→ε₂ may restrict the decay of strength(d).

### CONCLUSION

It should be understood that the examples and embodiments described herein are for illustrative purposes only and that various modifications or changes in light thereof will be suggested to persons skilled in the art and are to be included within the spirit and purview of this application.

Many modifications and other embodiments of the present disclosure set forth herein will come to mind to one skilled in the art to which the present disclosures pertain having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claim concepts. Although specific terms are employed herein, they are used in a generic and descriptive sense only and not for purposes of limitation.

### Appendix of Example Algorithms

ALGORITHM 1
STORE

| | |
|---|---|
| 1: | procedure STORE(M EM, D, G, H P) |
| 2: | while size(D) > remaining_epoca(MEM) do |
| 3: | RETENTION (MEM, HP) |
| 4: | if neuron_Count(MEM) == 0 then |
| 5: | Initial_Insertion(MEM, D, C, HP) |
| 6: | else |
| 7: | [Loc,Oₙ, Flag,Cₙ] = SEARCH_Point(M EM, C, HP) |
| 8: | [access_Path, Flag,C₁) = SEARCH(MEM, C, HP, Loc,Cₙ, HP → π₁) |
| 9: | LEARN_STORE(MEM, C, HP, D, Flag_Cₙ,access_Path, Flag_C₁) |

ALGORITHM 2
SEARCH

| | |
|---|---|
| 1: | procedure SEARCH(M EM, C, HP, ep, limit) |
| 2: | neuronQueue = [(ep, −1)], bestCandidate_Sim = −1, bestCandidate = 0, visited = [ ] |
| 3: | traversalMotion = [ ] |
| 4: | while len(neuronqueue)! = 0 do |
| 5: | if limit! = −1 & len(visited) >= limit then |
| 6: | break |
| 7: | (neuron, parentNeuron) = neuronQueue,dequeue() |
| 8: | if neuron ∉ visited then |
| 9: | if H P → w == 0 or isCueNeuron(neuron) == False or level(nueron)! = n then |
| 10: | traversalMotion,append((parentNeuron, neuron)) |
| 11: | if is CueNeuron(neuron) == True & level(neuron) == 1 then |
| 12: | C1 = C → level_1_cue |
| 13: | sim = compute_Similarity(neuron,C1) |
| 14: | if sim > HP →λₗ then |
| 15: | access_Path = compute_Access_Path(traversalMotion, nueron) |
| 16: | return [access_Path, 1] |
| 17: | else if sim > bestCandidate_sim then |
| 18: | bestCandidate_Sim = sim |
| 19: | bestCandidate = neuron |
| 20: | visited.append(neuron) |
| 21: | n = sort_descending(neighbours(neuron)) |
| 22: | index = 0 |
| 23: | while index < len(n) do |
| 24: | neuronQueue.enqueue(n[index]) |
| 25: | index + + |
| 26: | access_Path = compute_Access_Path(traversalMotion, bestCandidate) |
| 27: | return [access_Path, 0] |

ALGORITHM 3
LEARN_STORE

| | |
|---|---|
| 1: | procedure LEARN_STORE(M EM, C, H P, D, Flag_Cₙ, access_Flag_C₁) |
| 2: | if Flag_Cₙ == 1 & Flag_C1 == 1 then |
| 3: | strength_Associated_DN (access_Path[−1], H P) |
| 4: | INC_ACCESSIBILITY (M EM, C → level_n_cue, H P) |
| 5: | else if Flag_Cₙ == 0 & Flag_C₁ == 1 then |
| 6: | newCN = make_new_CN(M EM, C → level_n_cue, H P) |
| 7: | Associate(M EM, newCN, access_Path[−1], H P) |
| 8: | strengthen_Associated_DN(access_PAth[−1], H P) |
| 9: | INC_ACCESSIBILITY (M EM, H P, access_Path) |
| 10: | else if Flag_Cₙ, = = 1 & Flag_C₁ == 0 then |
| 11: | newCN = make_new_CN(M EM, C → level_1_cue, H P) |
| 12: | newDN = make_new_DN(M EM, D, H P) |
| 13: | associate(M EM, newCN, newDN, H P) |
| 14: | associate(M EM, newDN, access_Path[−1], H P) |
| 15: | INC_ACCESSIBILITY (M EM, H P, access_Path) |
| 16: | else if Flag_Cₙ == 0 & Flag_C₁ == 0 then |
| 17: | newCN_ [symbol] = make_new_CN(M EM, C → level_l_cue, H P) |
| 18: | newCN_ [symbol] = make_new_CN(M EM, C → level_n_cue, H P) |
| 19: | newDN = make_new_DN(M EM, D, H P) |
| 20: | associate(M EM, newCN_ [symbol] , newDN_ [symbol] , H P) |
| 21: | associate(M EM, newCN_ [symbol] , newDN, H P) |
| 22: | associate(M EM, newCN_ [symbol] , access_Path[−1], H P) |
| 23: | INC_ACCESSIBILITY (M EM, HP, access_Path) |

[symbol]

indicates data missing or illegible when filed

ALGORITHM 4
INC_ACCESSIBILITY

| | |
|---|---|
| 1: | procedure INC_ACCESSIBILITY (M EM, H P, access_Path) |
| 2: | if len(access_path) > 2 then |
| 3: | pull_str = min(len(access_path) −2, max(1, H P → _{ηs})) |
| 4: | associate(M EM, access_path[−(2 + pull_str)], access_path[−1], H P) |
| 5: | else if len(access_Path) == 2 then |
| 6: | strengthen_association(M EM, access_Path[0], access_Path[1], H P) |

ALGORITHM 5
RETRIEVE

| | |
|---|---|
| 1: | procedure RETRIEVE (M EM, C, H.P) |
| 2: | D = NULL |
| 3: | if neuron_Count(M EM) == 0 then |
| 4: | return D |
| 5: | else |
| 6: | [loc_Cₙ, Flag_Cₙ] = find_Entry_Point(M EM, C, H P) |
| 7: | [access_Path, Flag_C1] = SEARCH(M EM, C, H P, Loc_Cₙ, H P → π₂) |
| 8: | D = LEARN_RETRIEVE(M EM, C, H P, access_Path[1], H P) |
| 9: | return D |

ALGORITHM 6
LEARN_RETRIEVE

| | |
|---|---|
| 1: | procedure LEARN_RETRIEVE(M EM, C, HP, access_Path, Flag_C₁) |
| 2: | If Flag_C₁ == 1 then |
| 3: | DN = associated_DN (access_Path[−1], H P) |
| 4: | strengthen_Associated_DN(access_Path[−1], H P) |
| 5: | INC_ACCESSIBILITY(M EM, H P, access_Path) |
| 6: | return DN |
| 7: | else if Play_C1 == 0 then |
| 8: | return NULL |

ALGORITHM 7
RETENTION

| | |
|---|---|
| 1: | procedure RETENTION(M EM, H P) |
| 2: | A = M EM → Associations |
| 3: | D = M EM → Data_Neurons |
| 4: | for each α ϵ [symbol] do |
| 5: | Weaken(α, H P) |
| 6: | if strength(α) <= 0 then |
| 7: | delete(α) |
| 8: | for each d ϵ [symbol] do |
| 9: | d_str_new = reduce_mem_str(d, H P) |
| 10: | if d_str_new <= 0 then |
| 11: | deleted(d) |
| 12: | else |
| 13: | Compress_M em(d, d_str_new, HP) |

What is claimed is:

1. A computing entity comprising a memory system and one or more processors communicatively coupled to the memory system, the one or more processors configured to:
receive one or more storage parameters, the one or more storage parameters comprising input data and features associated with the input data;
determine a store procedure cue neuron search location from candidate ones of a plurality of cue neurons associated with a neural memory network (NoK), the store procedure cue neuron search location comprising a most similar one of the plurality of cue neurons to the input data based on the features associated with the input data;
insert the input data as a data neuron into the NoK based on the store procedure cue neuron search location;
temporally link the data neuron with a location of last insertion; and
modify the NoK in a manner of accessibility based on a pattern of a search for the most similar one of the plurality of cue neurons.

2. The computing entity of claim 1, wherein the one or more processors are further configured to:
determine the input data is salient with respect to data in proximity to the store procedure cue neuron search location based on a saliency threshold value; and
insert the input data into the NoK based on the determination that the input data is salient.

3. The computing entity of claim 1, wherein the one or more processors are further configured to:
determine the input data is not salient with respect to data in proximity to the store procedure cue neuron search location based on a saliency threshold value;
increase memory strength of data in proximity to the neuron search location based on the determination that the input data is not salient; and
temporally link the neuron search location with the location of last insertion.

4. The computing entity of claim 1, wherein the one or more processors are further configured to:
perform the search for the most similar one of the plurality of cue neurons until a search limit value is reached;
insert the input data as the data neuron in a best location of the NoK encountered during the search; and
temporally link the data neuron to the location of last insertion.

5. The computing entity of claim 1, wherein the one or more processors are further configured to:
receive one or more retrieval parameters, the one or more retrieval parameters comprising search features associated with a data request;
fetch data based on a determination that a retrieve procedure cue neuron search location is in proximity to data matching the search features;
increase memory strength of the fetched data; and
modify the NoK in a manner of accessibility based on a pattern of a search for the retrieve procedure cue neuron search location.

6. The computing entity of claim 5, wherein the one or more retrieval parameters comprise gist information associated with the data request.

7. The computing entity of claim 6, wherein the one or more processors are further configured to select a next candidate cue neuron in the NoK neighbor for a potential next search step based on NoK connectivity and the gist information until the data matching the search features is in proximity to the retrieve procedure cue neuron search location.

8. The computing entity of claim 1, wherein the one or more processors are further configured to:
receive one or more retrieval parameters comprising search features, a search limit value, gist information, and a data limit value;
generate a results data structure;
determine that a multi-retrieve procedure cue neuron search location is in proximity to data matching the search features;
fetch and append data to the results data structure based on the data matching the search features;
increase memory strength of the data appended to the results data structure;
modify the NoK in a manner of accessibility based on a pattern of a search for the multi-retrieve procedure cue neuron search location; and
return the results data structure comprising a plurality of data elements as output.

9. The computing entity of claim 1, wherein the one or more processors are further configured to:
receive one or more retrieval parameters comprising search features, a search limit value, gist information, a temporal limit value, and a near or far value;
generate a results data structure;
determine that a spatio-temporal cue neuron search location is in proximity to data matching the search features;
determine the data matching the search features is temporally consistent with the gist information based on the near or far value;
fetch and append data to the results data structure based on the data matching the search features is temporally consistent with the gist information;
increase memory strength of the data appended to the results data structure;
modify the NoK in a manner of accessibility based on a pattern of a search for the spatio-temporal cue neuron search location; and
return the results data structure comprising a sequence of data as output.

10. The computing entity of claim 9, wherein the one or more processors are further configured to:
determine whether the data matching the search features is within a distance of the temporal limit value from other elements in the results data structure based on the near or far value comprising a near value; and
determine whether the data matching the search features is at least the distance of the temporal limit value from the other elements in the results data structure based on the near or far value comprising a far value.

11. The computing entity of claim 1, wherein the one or more processors are further configured to:
receive a background identifier threshold and an activity highlight distance value;
select one or more data neurons from the NoK within a degree greater than the background identifier threshold as background data neurons;
for each background data neuron, perform a plurality of traces comprising unique paths to the background data neuron within the activity highlight distance value of hops; and
return the plurality of traces comprising referential activities as output.

12. The computing entity of claim 1, wherein the one or more processors are further configured to:
mark key data point locations in the NoK;
assign a score to a data point at each of the key data point locations; and
fetch one or more top key data points based on a search limit and respective scores of the one or more top key data points.

13. The computing entity of claim 1, wherein the NoK comprises one or more compute neurons and one or more data neurons, wherein the one or more compute neurons are configured to perform one or more operations on the one or more data neurons.

14. The computing entity of claim 13, wherein the one or more operations comprise one or more of creating new knowledge, updating data, or generating responses to queries.

15. The computing entity of claim 13, wherein the one or more compute neurons are located at one or more regions of the NoK comprising at least one of the one or more data neurons on which the one or more compute neurons are most likely to operate on.

16. The computing entity of claim 1, wherein the NoK is distributed across a plurality of computing entities.

17. The computing entity of claim 16, wherein at least one of the plurality of computing entities is spatially aware of memory content of a second one of the plurality of computing entities via the NoK.

18. The computing entity of claim 1, wherein the NoK comprises one or more neurons configured to move across the plurality of computing entities based on one or more of change in data access behavior, change in data movement requirements, change in compute requirements, or memory user feedback.

19. The computing entity of claim 1, wherein the one or more processors are further configured to:
reduce association strengths of one or more of the plurality of cue neurons and one or more data neurons in the neural memory network; and
reduce memory strength of the one or more data neurons in the neural memory network.

20. The computing entity of claim 1, wherein the NoK comprises one or more memory hives associated with one or more respective data types.
